(19) United States
(12) Patent Application Publication
(10) Pub. No.: US 2025/0095637 A1
(43) Pub. Date: Mar. 20, 2025

(54) MULTILINGUAL AND CODE-SWITCHING ASR USING LARGE LANGUAGE MODEL GENERATED TEXT

(71) Applicant: Google LLC, Mountain View, CA (US)

(72) Inventors: Ke Hu, Stony Brook, NY (US); Tara N. Sainath, Jersey City, NJ (US); Bo Li, Fremont, CA (US); Yu Zhang, Mountain View, CA (US); Yong Cheng, Mountain View, CA (US); Tao Wang, Sunnyvale, CA (US); Yujing Zhang, Sunnyvale, CA (US); Frederick Liu, Bellevue, WA (US)

(73) Assignee: Google LLC, Mountain View, CA (US)

(21) Appl. No.: 18/886,581

(22) Filed: Sep. 16, 2024

Related U.S. Application Data
(60) Provisional application No. 63/584,051, filed on Sep. 20, 2023.

(51) Int. Cl. G10L 15/06; G10L 15/00

(52) U.S. Cl. CPC G10L 15/063; G10L 15/005

(57) ABSTRACT

A method includes receiving a textual prompt in a first language and obtaining a fine-tuned prompt embedding configured to guide a large language model (LLM) to generate text in a target language from textual prompts in the first language. The method also includes processing, using the LLM, the textual prompt conditioned on the fine-tuned prompt embedding to generate output text in the target language and concatenating the textual prompt and the generated output text to provide an unspoken textual utterance. The method also includes training a multilingual automatic speech recognition (ASR) model to learn how to recognize speech in the target language by injecting the unspoken textual utterance into a text encoder associated with the multilingual ASR model.

### CROSS REFERENCE TO RELATED APPLICATIONS

This U.S. Patent application claims priority under 35 U.S.C. § 119 (e) to U.S. Provisional Application 63/584,051, filed on Sep. 20, 2023. The disclosure of this prior application is considered part of the disclosure of this application and is hereby incorporated by reference in its entirety.

### TECHNICAL FIELD

This disclosure relates to multilingual and code-switching ASR using large language model generated text.

### BACKGROUND

Automatic speech recognition (ASR), the process of taking an audio input and transcribing it into text, has greatly been an important technology that is used in mobile devices and other devices. In general, automatic speech recognition attempts to provide accurate transcription of what a person has said by taking an audio input (e.g., speech utterance) and transcribing the audio input into text. Modern ASR models continue to improve in both accuracy (e.g., low word error (WER)) and latency (e.g., delay between the client speaking and the transcription) based on the ongoing development of deep neural networks. However, one challenge in developing deep learning-based ASR models is the parameters of the ASR models tend to over fit the training data, thereby resulting in the ASR models having difficulties generalizing unseen data when the training data is not extensive enough. As a result, training ASR models on larger training datasets improves the accuracy of the ASR model. Injecting text-only into ASR models can be incorporated to increase the volume of training data used to train the ASR models.

### SUMMARY

One aspect of the disclosure provides a computer-implemented method that when executed on data processing hardware causes the data processing hardware to perform operations for training multilingual and code-switching ASR using large language model generated text. The operations include receiving a textual prompt in a first language and obtaining a fine-tuned prompt embedding configured to guide a large language model (LLM) to generate text in a target language from textual prompts in the first language. The operations also include processing, using the LLM, the textual prompt conditioned on the fine-tuned prompt embedding to generate output text in the target language and concatenating the textual prompt and the generated output text to provide an unspoken textual utterance. The operations also include training a multilingual automatic speech recognition (ASR) model to learn how to recognize speech in the target language by injecting the unspoken textual utterance into a text encoder associated with the multilingual ASR model.

Implementations of the disclosure may include one or more of the following optional features. In some implementations, the output text generated in the target language includes monolingual text in the first language. Here, the textual prompt may include a prefix of a seed sentence in the first language and the seed sentence is sampled from a set of multilingual seed sentences. The set of multilingual seed sentences include a plurality of monolingual seed sentence subsets each including corresponding seed sentences in a respective language different than the respective language of the corresponding seed sentences of each other monolingual seed sentence subset. In these implementations, the fine-tuned prompt may be learned during a fine-tuning process by: obtaining a randomly initialized trainable prompt embedding; obtaining a multilingual training dataset that includes a plurality of training data subsets each including corresponding monolingual training text utterances in a respective language that is different than the respective language of the corresponding monolingual training text utterances included in each other training data subset; for each monolingual training text utterance, tokenizing the monolingual training utterance into a sequence of corresponding sub-word units and processing, using the LLM, the sequence of corresponding sub-word units to determine a training loss that maximizes a probability of predicting a next sub-word unit based on each of the preceding sub-word units in the sequence of sub-word units; and fine-tuning, using the training losses, the randomly initialized trainable prompt embedding while parameters of the LLM are kept fixed. Here, each corresponding training data subset of the plurality of training data subsets includes one or more corresponding transcribed speech utterances each represented by a corresponding sequence of acoustic frames and is paired with a corresponding transcription represented by a corresponding one of the monolingual training text utterances in the corresponding training data subset and training the multilingual speech recognition model further includes training the multilingual speech recognition model on each of the one or more corresponding transcribed speech utterances in each corresponding training data subset of the plurality of training data subsets.

In some examples, the output text generated in the target language includes text in a second language different than the first language. Here, the textual prompt may include a prefix of a seed sentence in the first language where the seed sentence is sampled from a set of code-mixed seed sentences. Each code-mixed seed sentence includes corresponding code-mixed text in both the first language and the second language. In these examples, the fine-tuned prompt embedding is learned during a fine-tuning process by: obtaining a randomly initialized trainable prompt embedding; obtaining a code-mixed training dataset that includes a plurality of code-mixed training text utterances that each includes code-mixed text in the first language and the second language; for each code-mixed training text utterance, tokenizing the code-mixed training text utterance into a sequence of corresponding sub-word units and processing, using the LLM, the sequence of corresponding sub-word units to determine a training loss that maximizes a probability of predicting a next sub-word unit based on each of the preceding sub-word units in the sequence of sub-word units; and fine-tuning, using the training losses, the randomly initialized trainable prompt embedding while parameters of the LLM are kept fixed. Here, the code-mixed training dataset may include one or more corresponding transcribed code-mixed speech utterances each represented by a corresponding sequence of acoustic frames and is paired with a corresponding transcription represented by a corresponding one of the code-mixed training text utterances and training the multilingual speech recognition model further includes training the multilingual speech recognition model on each of the one or more corresponding transcribed code-mixed speech utterances in the code-mixed training dataset.

The LLM may be pre-trained on a diverse range of text data sourced from web documents, books, and code. In some implementations, training the multilingual ASR model to learn how to recognize speech in the target language by injecting the unspoken textual utterance into the text encoder associated with the multilingual ASR model includes: tokenizing the unspoken textual utterance into a sequence of sub-word units; generating, by the text encoder of an encoder, at each of a plurality of output steps, a first higher order textual feature representation for a corresponding sub-word unit in the sequence of sub-word units tokenized from the unspoken textual utterance; receiving, as input to a first-pass decoder, the first higher order textual feature representation generated by the text encoder at each of the plurality of output steps; generating, by the first-pass decoder, at each of the plurality of output steps, a first probability distribution over possible text units; and training the encoder based on the first probability distribution over possible text units generated by the first-pass decoder at each of the plurality of output steps for the unspoken textual utterance. In these implementations, the operations may further include: receiving, as input to a non-causal audio-text encoder of the encoder, the first higher order textual feature representation generated by the text encoder at each of the plurality of output steps; generating, by the non-causal audio-text encoder, at each of the plurality of output steps, a second higher order textual feature representation for a corresponding first higher order textual feature representation; receiving, as input to a second-pass decoder, the second higher order textual feature representation generated by the non-causal audio-text encoder at each of the plurality of output steps; and generating, by the second decoder, at each of the plurality of output steps, a second probability distribution over possible text units. Here, training the encoder is further based on the second probability distribution over possible text units generated by the second-pass decoder at each of the plurality of output steps for the unspoken textual utterance. The first-pass decoder and the second-pass decoder may include a same decoder. The non-causal audio-text encoder may include one of a plurality of unidirectional long short-term memory (LSTM) layers, a plurality of conformer layers, or a plurality of transformer layers.

Another aspect of the disclosure provides a system that includes data processing hardware and memory hardware storing instructions that when executed on the data processing hardware causes the data processing hardware to perform operations. The operations include receiving a textual prompt in a first language and obtaining a fine-tuned prompt embedding configured to guide a large language model (LLM) to generate text in a target language from textual prompts in the first language. The operations also include processing, using the LLM, the textual prompt conditioned on the fine-tuned prompt embedding to generate output text in the target language and concatenating the textual prompt and the generated output text to provide an unspoken textual utterance. The operations also include training a multilingual automatic speech recognition (ASR) model to learn how to recognize speech in the target language by injecting the unspoken textual utterance into a text encoder associated with the multilingual ASR model.

Implementations of the disclosure may include one or more of the following optional features. In some implementations, the output text generated in the target language includes monolingual text in the first language. Here, the textual prompt may include a prefix of a seed sentence in the first language and the seed sentence is sampled from a set of multilingual seed sentences. The set of multilingual seed sentences include a plurality of monolingual seed sentence subsets each including corresponding seed sentences in a respective language different than the respective language of the corresponding seed sentences of each other monolingual seed sentence subset. In these implementations, the fine-tuned prompt may be learned during a fine-tuning process by: obtaining a randomly initialized trainable prompt embedding; obtaining a multilingual training dataset that includes a plurality of training data subsets each including corresponding monolingual training text utterances in a respective language that is different than the respective language of the corresponding monolingual training text utterances included in each other training data subset; for each monolingual training text utterance, tokenizing the monolingual training utterance into a sequence of corresponding sub-word units and processing, using the LLM, the sequence of corresponding sub-word units to determine a training loss that maximizes a probability of predicting a next sub-word unit based on each of the preceding sub-word units in the sequence of sub-word units, and fine-tuning, using the training losses, the randomly initialized trainable prompt embedding while parameters of the LLM are kept fixed. Here, each corresponding training data subset of the plurality of training data subsets includes one or more corresponding transcribed speech utterances each represented by a corresponding sequence of acoustic frames and is paired with a corresponding transcription represented by a corresponding one of the monolingual training text utterances in the corresponding training data subset and training the multilingual speech recognition model further includes training the multilingual speech recognition model on each of the one or more corresponding transcribed speech utterances in each corresponding training data subset of the plurality of training data subsets.

In some examples, the output text generated in the target language includes text in a second language different than the first language. Here, the textual prompt may include a prefix of a seed sentence in the first language where the seed sentence is sampled from a set of code-mixed seed sentences. Each code-mixed seed sentence includes corresponding code-mixed text in both the first language and the second language. In these examples, the fine-tuned prompt embedding is learned during a fine-tuning process by: obtaining a randomly initialized trainable prompt embedding; obtaining a code-mixed training dataset that includes a plurality of code-mixed training text utterances that each includes code-mixed text in the first language and the second language; for each code-mixed training text utterance, tokenizing the code-mixed training text utterance into a sequence of corresponding sub-word units and processing, using the LLM, the sequence of corresponding sub-word units to determine a training loss that maximizes a probability of predicting a next sub-word unit based on each of the preceding sub-word units in the sequence of sub-word units, and fine-tuning, using the training losses, the randomly initialized trainable prompt embedding while parameters of the LLM are kept fixed. Here, the code-mixed training dataset may include one or more corresponding transcribed code-mixed speech utterances each represented by a corresponding sequence of acoustic frames and is paired with a corresponding transcription represented by a corresponding one of the code-mixed training text utterances and training the multilingual speech recognition model further includes training the multilingual speech recognition model on each of the one or more corresponding transcribed code-mixed speech utterances in the code-mixed training dataset.

The LLM may be pre-trained on a diverse range of text data sourced from web documents, books, and code. In some implementations, training the multilingual ASR model to learn how to recognize speech in the target language by injecting the unspoken textual utterance into the text encoder associated with the multilingual ASR model includes: tokenizing the unspoken textual utterance into a sequence of sub-word units; generating, by the text encoder of an encoder, at each of a plurality of output steps, a first higher order textual feature representation for a corresponding sub-word unit in the sequence of sub-word units tokenized from the unspoken textual utterance; receiving, as input to a first-pass decoder, the first higher order textual feature representation generated by the text encoder at each of the plurality of output steps; generating, by the first-pass decoder, at each of the plurality of output steps, a first probability distribution over possible text units; and training the encoder based on the first probability distribution over possible text units generated by the first-pass decoder at each of the plurality of output steps for the unspoken textual utterance. In these implementations, the operations may further include: receiving, as input to a non-causal audio-text encoder of the encoder, the first higher order textual feature representation generated by the text encoder at each of the plurality of output steps; generating, by the non-causal audio-text encoder, at each of the plurality of output steps, a second higher order textual feature representation for a corresponding first higher order textual feature representation; receiving, as input to a second-pass decoder, the second higher order textual feature representation generated by the non-causal audio-text encoder at each of the plurality of output steps; and generating, by the second decoder, at each of the plurality of output steps, a second probability distribution over possible text units. Here, training the encoder is further based on the second probability distribution over possible text units generated by the second-pass decoder at each of the plurality of output steps for the unspoken textual utterance. The first-pass decoder and the second-pass decoder may include a same decoder. The non-causal audio-text encoder may include one of a plurality of unidirectional long short-term memory (LSTM) layers, a plurality of conformer layers, or a plurality of transformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example speech recognition model.

FIGS. 3A-3D are schematic views of an example training process for training an encoder of the speech recognition model.

FIG. 4 is a schematic view of an example alignment model.

FIGS. 5A and SB are schematic views of text generation processes.

FIGS. 6A and 6B are schematic views of fine-tuning processes for a training prompt embedding.

FIG. 7 is a flowchart of an example arrangement of operations for a computer-implemented method of training multilingual and code-switching ASR using large language model generated text.

FIG. 8 is a schematic view of an example computing device that may be used to implement the systems and methods described herein.

Like reference symbols in the various drawings indicate like elements.

### DETAILED DESCRIPTION

One challenge in developing deep learning-based automatic speech recognition (ASR) models is that parameters of the ASR models tend to over fit the training data, thereby resulting in the ASR models having difficulties generalizing unseen data when the training data is not extensive enough. Thus, training ASR models on larger training datasets improves the accuracy of the ASR model. For instance, the user of machine learning or other statistical methods can train ASR models on training data sets that include upwards of 10,000 hours of transcribed speech. Yet, performance of ASR models suffers when a domain associated with training data is distinct from a domain at which the ASR model will be deployed during inference. For example, training an ASR model on transcribed speech in a domain associated with video meetings would be less effective in recognizing speech related to voice search queries, and vice versa.

Unpaired text data has the potential to drastically limit the amount of labeled human speech required to train ASR models. In particular, some training configurations use text-injection methods or use text-to-speech models to leverage the unpaired text data and train ASR models in a semi-supervised fashion. Generally speaking, vast amounts of unpaired text data is readily available to train ASR models. In some scenarios, however, the availability of text data is limited, for example, text data for certain low-resource languages and code-switching text data. Here, code-switching text data refers to single textual utterances that include two or more different languages.

Implementations herein are directed towards systems and methods for training a multilingual ASR model using large language model (LLM) generated text. In particular, a pre-trained LLM receives a textual prompt in a first language and obtains a fine-tuned prompt embedding configured to guide the LLM to generate text in a target language from textual prompts in the first language. During a text generation process, the LLM processes the textual prompt conditioned on the fine-tuned prompt embedding to generate output text in the target language. As will become apparent, the target language may include monolingual text or code-switched text. Thereafter, the text generation process concatenates the textual prompt and the generated output text to provide an unspoken textual utterance. Using the unspoken textual utterances generated by the text generation process, a training process trains a multilingual ASR model to learn how to recognize speech in the target language by injecting the unspoken textual utterance into a text encoder associated with the multilingual ASR model. Notably, the fine-tuned prompt embedding includes a trainable embedding instead of a manually created text prompt so that the pre-trained LLM can generate the output text in the target language without tuning or updating parameters of the LLM. Advantageously, the fine-tuned prompt embedding conditions the LLM to generate text in the target language from textual prompts without a user manually generating textual prompts to guide the LLM or training a new task-specific LLM.

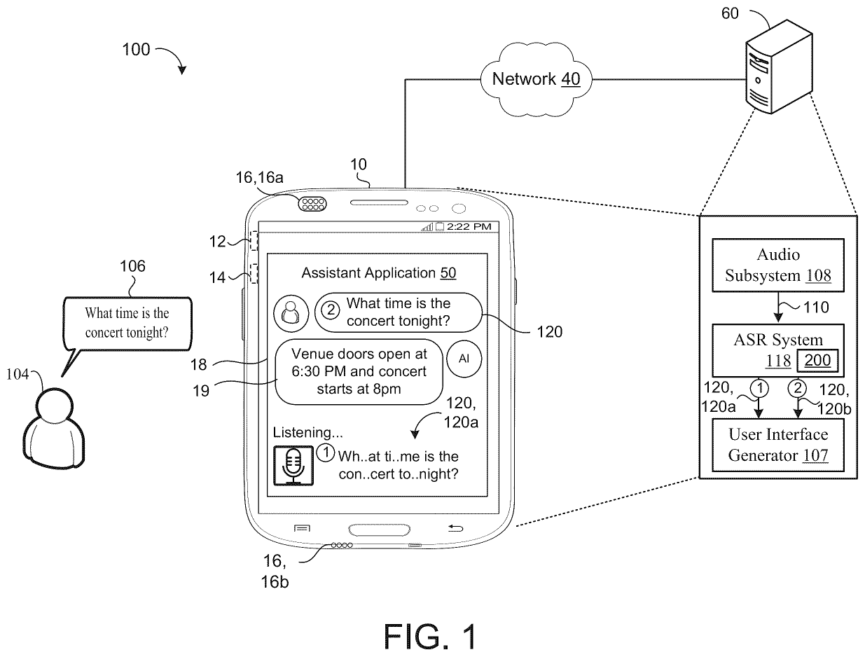

FIG. 1 is an example of a speech recognition system 100. In the speech recognition system 100, a user's 104 manner of interacting with a computing device, such as a user device 10, may be through voice input. The user device 10 (also referred to generally as a device 10) is configured to capture sounds (e.g., streaming audio data) from one or more users 104 within the speech recognition system 100. Here, the streaming audio data may refer to a spoken utterance 106 by the user 104 that functions as an audible query, a command for the user device 10, or an audible communication captured by the device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes an audio system 16 with an audio capture device (e.g., microphone) 16, 16a for capturing and converting spoken utterances 106 into electrical signals and a speech output device (e.g., a speaker) 16, 16b for communicating with an audible audio signal (e.g., as output data from the user device 10). While the user device 10 may implement an array of audio capture devices 16a without departing from the scope of the present disclosure, whereby one or more capture devices 16a in the array may not physically reside on the user device 10, but be in communication with the audio system 16.

In the speech recognition system 100, an automated speech recognition (ASR) system 118 implements an ASR model 200 and resides on the user device 10 of the user 104 and/or on a remote computing device 60 (e.g., one or more remote servers of a distributed system executing in a cloud-computing environment) in communication with the user device 10 via a network 40. In some examples, the ASR model 200 may be a recurrent neural network-transducer (RNN-T) model. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., sequence of acoustic frames) 110 for input to the ASR system 118. Thereafter, the ASR model 200 receives, as input, the sequence of acoustic frames 110 corresponding to the utterance 106, and generates/predicts, at each output step, a corresponding transcription 120 (e.g., speech recognition result/hypothesis) of the utterance 106 as the ASR model receives (e.g., processes) each acoustic frame 110 in the sequence of acoustic frames 110.

In the example shown, the ASR model 200 may perform streaming speech recognition to produce an initial speech recognition result 120, 120a and generate a final speech recognition result 120, 120b by improving the initial speech recognition result 120a. The speech recognition results 120 may either correspond to a partial speech recognition result or an entire speech recognition result. Stated differently, the speech recognition result 120 may either correspond to a portion of an utterance 106 or an entire utterance 106. For example, the partial speech recognition result may correspond to a portion of a spoken utterance or even a portion of a spoken term. However, as will become apparent, the ASR model 200 performs additional processing on the final speech recognition result 120b whereby the final speech recognition result 120b may be delayed from the initial speech recognition result 120a.

The user device 10 and/or the remote computing device 60 also executes a user interface generator 107 configured to present a representation of the transcription 120 of the utterance 106 to the user 104 of the user device 10. As described in greater detail below, the user interface generator 107 may display the initial speech recognition results 120a in a streaming fashion during time 1 and subsequently display the final speech recognition results 120b in a streaming fashion during time 2. Notably, the ASR model 200 outputs the final speech recognition results 120b in a streaming fashion even though the final speech recognition results 120b improve upon the initial speech recognition result 120a. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the initial speech recognition results 120a. During time 1, the user interface generator 107 presents, via the digital assistant interface 18, a representation of the initial speech recognition results 120a of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 18, a representation of the final speech recognition results 120b of the utterance 106 to the user 104 of the user device 10 a streaming fashion such that words, word pieces, and/or individual characters appear on the screen as soon as they are generated by the ASR model 200. In some implementations, the user interface generator 107 replaces the representation of the initial speech recognition results 120a presented at time 1 with the representation of the final speech recognition results 120b presented at time 2. Here, time 1 and time 2 may include timestamps corresponding to when the user interface generator 107 presents the respective speech recognition result 120. In this example, the timestamp of time 1 indicates that the user interface generator 107 presents the initial speech recognition results 120a at an earlier time than the final speech recognition results 120b. For instance, as the final speech recognition result 120b is presumed to be more accurate than the initial speech recognition result 120a, the final speech recognition result 120b ultimately displayed as the transcription 120 may fix any terms that may have been misrecognized in the initial speech recognition results 120a. In this example, the streaming initial speech recognition results 120a output by the ASR model 200 are displayed on the screen of the user device 10 at time 1 are associated with low latency and provide responsiveness to the user 104 that his/her query is being processed, while the final speech recognition result 120b output by the ASR model 200 and displayed on the screen at time 2 leverages an additional speech recognition model and/or a language model to improve the speech recognition quality in terms of accuracy, but at increased latency. However, since the initial speech recognition results 120a are displayed as the user speaks the utterance 106, the higher latency associated with producing, and ultimately displaying the final speech recognition results 120b is not noticeable to the user 104.

In the example shown in FIG. 1, the digital assistant application 50 may respond to the question posed by the user 104 using natural language processing. Natural language processing generally refers to a process of interpreting written language (e.g., the initial speech recognition result 120a and/or the final speech recognition result 120b) and determining whether the written language prompts any action. In this example, the digital assistant application 50 uses natural language processing to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on a remote server 60 in communication with the data processing hardware 12 of the user device 10.

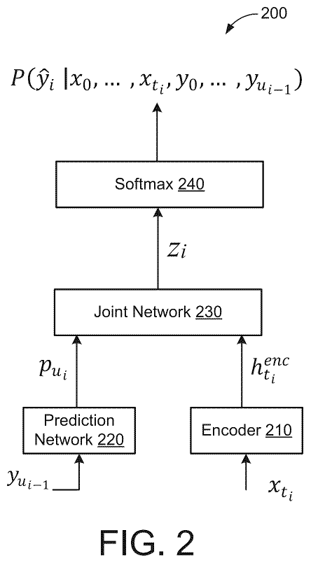

Referring to FIG. 2, an example ASR model 200 may include a Recurrent Neural Network-Transducer (RNN-T) model architecture which adheres to latency constraints with interactive applications. The use of the RNN-T model architecture is exemplary only, as the ASR model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder network (e.g., audio encoder) 210 reads a sequence of d-dimensional feature vectors (e.g., acoustic frames 110 (FIG. 1)) x=(x₁, x₂, . . . , x_{T}), where xₜϵ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Together, the prediction network 220 and the joint network 230 may be referred to as a decoder that includes an RNN-T architecture. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output zᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in the streaming fashion, the non-streaming fashion, or some combination thereof.

In some examples, the audio encoder (i.e., encoder) 210 of the RNN-T model includes a stack of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance 16 layers. Moreover, the encoder 210 may operate in the streaming fashion (e.g., the encoder 210 outputs initial higher-order feature representations as soon as they are generated), in the non-streaming fashion (e.g., the encoder 210 outputs subsequent higher-order feature representations by processing additional right-context to improve initial higher-order feature representations), or in a combination of both the streaming and the non-streaming fashion.

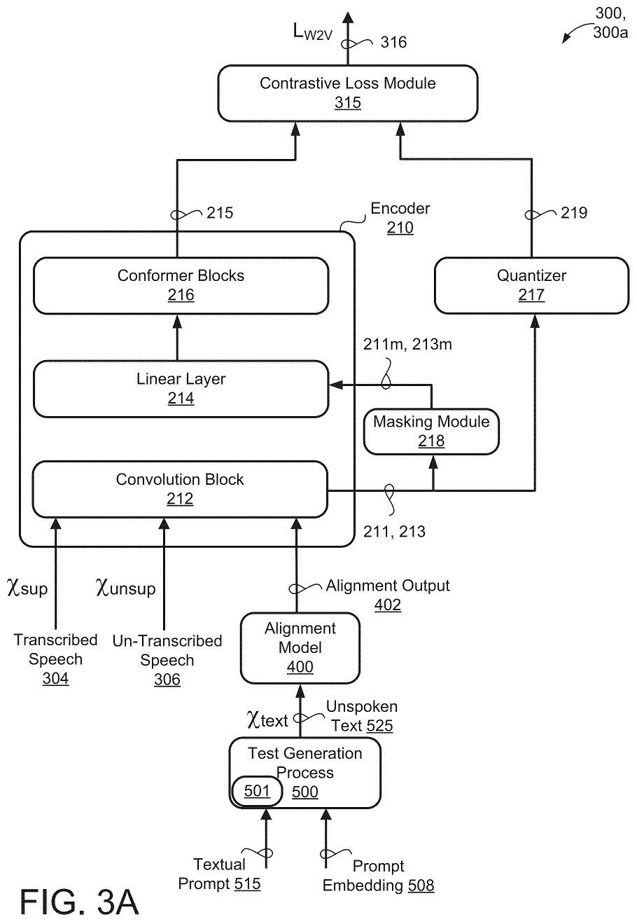

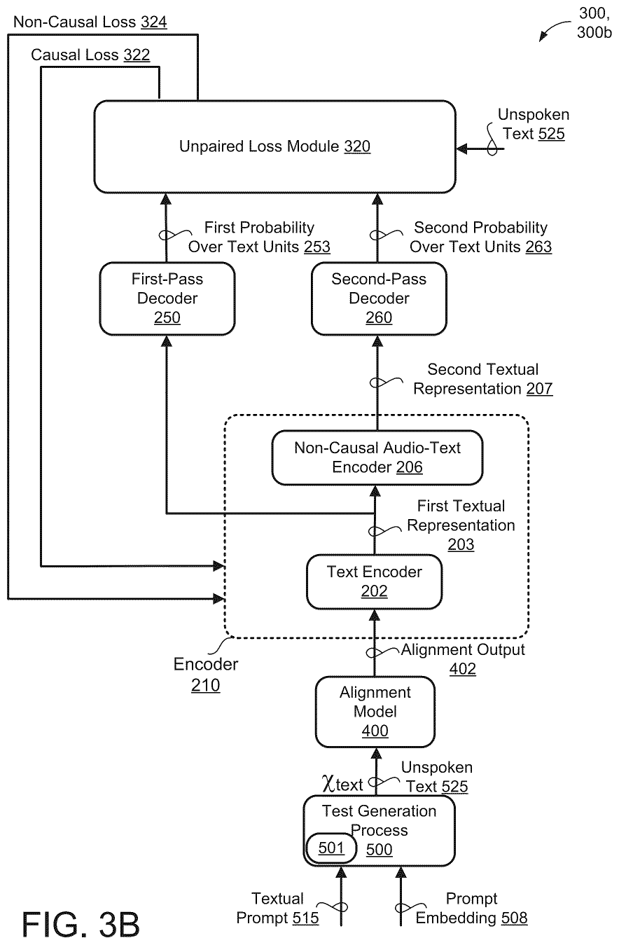

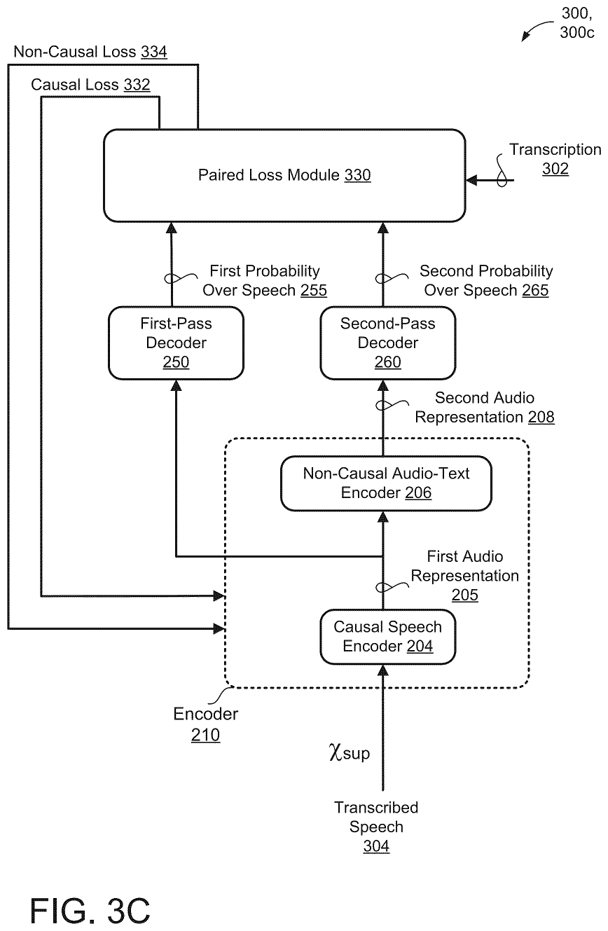

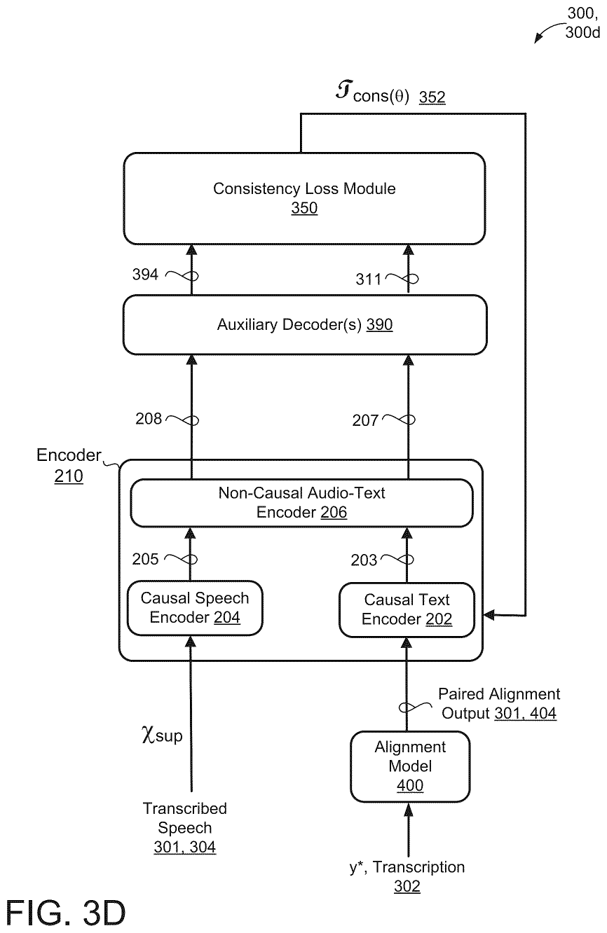

FIGS. 3A-3D illustrate an example training process 300 for training the ASR model 200 (FIG. 2). The training process 300 described herein describes training the encoder 210 of the ASR model 200, however, it is understood that the training process 300 may also include pre-training and/or fine-tuning the encoder 210. The ASR model 200 may be a multilingual ASR model (e.g., trained to recognize utterances in multiple different languages including code-mixed utterances that mix speech spoken across two or more different languages). Implementations described herein contemplate the training process 300 training the encoder 210 of the ASR model 200 without training the decoder (e.g., prediction network 220 and joint network 230 (FIG. 2)) of the ASR model 200. Yet, it is understood that the training process 300 may additionally, or alternatively, train other components of the ASR model 200 (e.g., prediction network 220 and/or joint network 230 (FIG. 2)) jointly with, or in lieu of, the encoder 210.

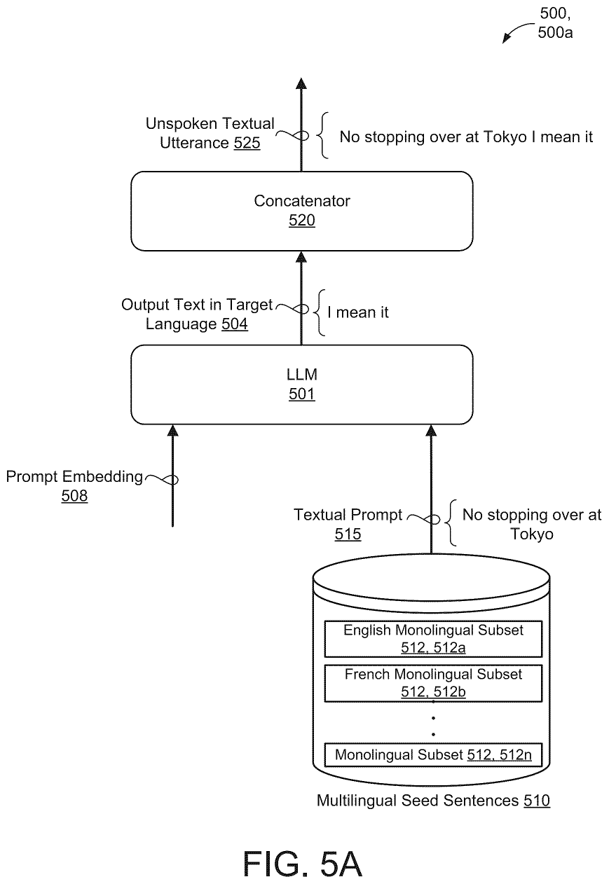

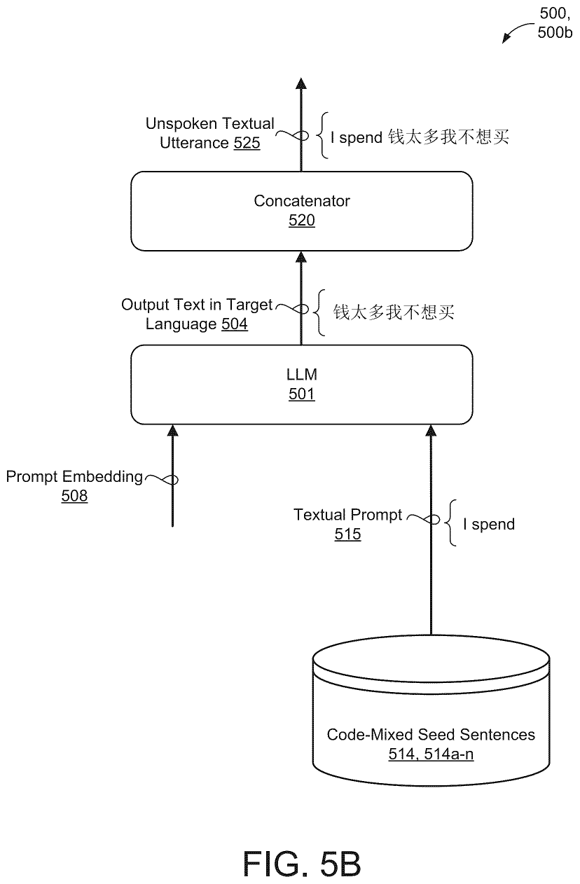

The training process 300 trains the audio encoder 210 using available training data that includes a set of unspoken textual utterances (Xₜₑₓₜ) 525, a set of transcribed non-synthetic speech utterances (Xₛᵤₚ) 304, and/or un-transcribed non-synthetic speech utterances (Xᵤₙₛᵤₚ) 306. As will become apparent, the set of unspoken textual utterances 525 may be generated by a text generation process 500 that employs a large language model (LLM) 501, described in greater detail below with reference to FIGS. 5A and 5B. Notably, each unspoken textual utterance 525 in the set of unspoken textual utterances 525 includes text-only data (i.e., unpaired data) in a target language such that each unspoken textual utterance 525 is not paired with any corresponding spoken audio representation (i.e., speech) of the utterance. Here, the target language is any language the training process 300 trains the audio encoder 210 to recognize. For instance, when training the multilingual ASR model 200 to recognize speech in N different languages, the set of unspoken textual utterances 525 may include N subsets of unspoken textual utterances 525 where each subset includes one or more unspoken textual utterances 525 in a respective one of the N different languages the multilingual ASR model 200 is being trained to recognize. Moreover, the set of unspoken textual utterances 524 may additionally or alternatively include code-mixed utterances of text that each include at least one word in a first language and at least one other word in a different second language. For example, “airport in [symbol] ” is a training utterance that includes a code-mixed script formed by words/terms in both English and Mandarin. As used herein, single utterances that include multiple languages are referred to as code-mixed (i.e., code-switched) utterances.

The unspoken textual utterance 525 may include any sequence of text chunks including words, word-pieces, phonemes, and/or graphemes. Each un-transcribed non-synthetic speech utterance 306 (also referred to as simply “un-transcribed speech utterance 306”) includes audio-only data (i.e., unpaired data) in the target language such that the un-transcribed speech utterance 306 is not paired with any corresponding transcription. On the other hand, each transcribed non-synthetic speech utterance 304 (also referred to as simply “transcribed speech utterance 304”) includes a corresponding transcription 302 paired with a non-synthetic speech representation of the respective transcribed speech utterance 304.

For simplicity, the training process 300 includes a contrastive loss part 300a (FIG. 3A), a semi-supervised loss part 300b (FIG. 3B), a supervised loss part 300c (FIG. 3C), and a consistency regularization part 300d (FIG. 3D). The training process 300 trains the encoder 210 on a total loss (Lₜₜₛ₄ₚᵣₑₜᵣₐᵢₙ₂) based on: contrastive losses (L_{w2v}) 316 derived using the contrastive self-supervised loss part 300a from the unspoken training text utterances (Xₜₑₓₜ) 525, the transcribed non-synthetic speech utterances (Xₛᵤₚ) 304, and the un-transcribed non-synthetic speech utterances (Xᵤₙₛᵤₚ) 306; semi-supervised losses 322, 324 derived using the semi-supervised loss part 300b from the unspoken training text utterances (Xₜₑₓₜ) 525; supervised losses 332, 334 derived using the supervised loss part 300c from the transcribed non-synthetic speech utterances (Xₛᵤₚ) 304; and consistency losses ( [symbol] _{cons}(θ)) 352 derived using the consistency regularization part 300d.

Referring to FIG. 3A, the contrastive loss part 300a of the training process 300 may use the text generation process 500 that employs the LLM 501 configured to receive, as input, a textual prompt 515 in a first language and a fine-tuned prompt embedding 508 and generate, as output, output text 504 (FIGS. 5A and 5B) concatenated with the textual prompt 515 to form a corresponding one of the unspoken textual utterances 525. As discussed above, the text generation process 500 may generate unspoken textual utterances 525 in multiple different languages, including some unspoken textual utterances 525 that code-mix between two or more different languages. Moreover, and as described in greater detail below with reference to FIGS. 5-7, the fine-tuned prompt embedding 508 conditions the LLM 501 to generate the output text 504 (FIGS. 5A and 5B) in the target language which may be the same language or a different language than the language of the textual prompt 515 provided as input to the LLM 501. The contrastive loss part 300a also employs an alignment model 400 that is configured to receive, as input, the plurality of unspoken textual utterances 525 generated by the LLM. 501 and generate, at each of a plurality of output steps, a corresponding alignment output (i.e., textual representation) 402 for each respective unspoken textual utterance 525.

The LLM 501 may include about one billion parameters in total. The LLM 501 may include a transformer architecture. In some examples, the LLM 501 includes the Pathway Language Model 2 (PaLM 2) using a 256K sentence piece model for tokenization and a transformer input dimension of 1536.

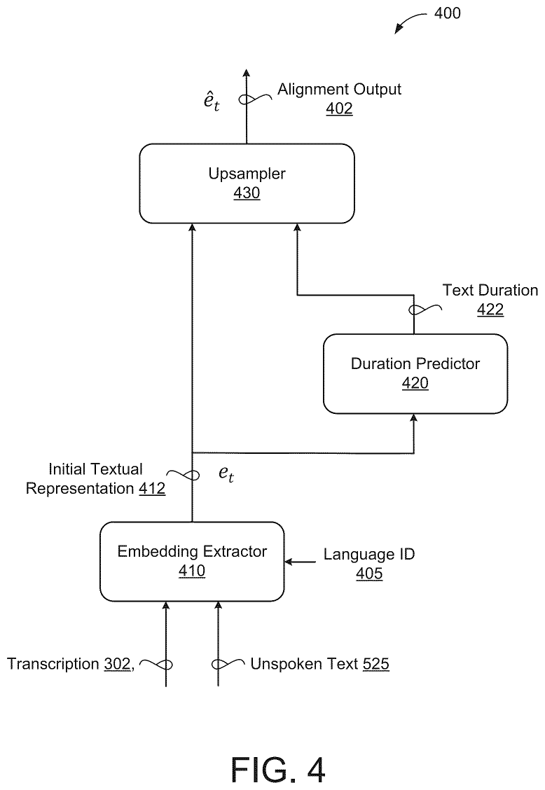

Referring now to FIG. 4, in some examples, the alignment model 400 includes an embedding extractor 410, duration predictor 420, and an upsampler 430. The embedding extractor 410 receives the unspoken textual utterance 525 that includes a sequence of text chunks including words, word-pieces, phonemes, and/or graphemes and extracts a corresponding initial textual representation (et) 412. The initial textual representation 412 includes embedding lexical information from the unspoken textual utterance 525. Additionally or alternatively, the embedding extractor 410 may receive a transcription 302 corresponding to a transcribed non-synthetic speech utterance 304 (FIG. 3D) and extracts the corresponding initial textual representation 412. The duration predictor 420 receives the initial textual representation 412 from the embedding extractor 410 and predicts a corresponding text chunk duration (i.e., word, word-piece, phoneme, and/or grapheme duration) 422. The text chunk duration 422 indicates a duration the corresponding text chunk would be spoken if a human (or text-to-speech system) spoke the unspoken textual utterance 525 in the target language. For example, the unspoken textual utterance 525 may include a sequence of phonemes and the duration predictor 420 predicts a phoneme duration 422 for each phoneme in the sequence of phonemes. In this example, the duration predictor 420 predicts the phoneme duration 422 by predicting a probability of non-zero duration for each phoneme and predicting a probability of continuous phoneme duration for each phoneme. As the sequence of phonemes includes regular phonemes, silences between word boundaries, and punctuation marks, only the regular phonemes are associated with non-zero duration while the silences and punctuation marks are generally associated with the continuous phoneme duration. Accordingly, the duration predictor 420 may use a sigmoid activation following a first one of two independent activations to predict the probability of non-zero duration and use a soft plus activation following a second one of the two independent projections to predict the continuous text chunk duration 422 for each text chunk. The duration predictor 420 determines, for each text chunk, whether the probability of non-zero duration is less than a threshold value, and when the probability of non-zero duration is less than the threshold value, a multiplier may zero-out the continuous text chunk duration 422 predicted by the softplus activation for the corresponding text chunk. Otherwise, when the probability of non-zero duration is not less than the threshold value, the predicted text chunk duration 422 may be set equal to the continuous phoneme duration predicted by the softplus activation.

The upsampler 430 receives, for each unspoken textual utterance 525 (or transcription 302), the corresponding initial textual representation 412 and the predicted text chunk duration 422, and generates an alignment output (êₜ) 402 having a number of frames by upsampling the initial textual representation 412 using the corresponding predicted text chunk duration 422. Here, the alignment output 402 represents an aligned speech-text representation. In some examples, the alignment model 400 sends the alignment output 402 to a text encoder 202 of the encoder 210 (FIGS. 3B and 3D). In other examples (not shown), the alignment model 400 sends the alignment output 402 to a non-causal audio-text encoder 306 (e.g., bypassing the text encoder 202) of the encoder 210. In these other examples, the alignment output 402 serves as the first higher order textual feature representation 203 such that the non-causal audio-text encoder 206 may receive the alignment output 402 directly from the alignment model 400. In yet other examples, paired training data is available and the upsampler 430 generates the alignment output 402 as follows:

$${\hat{e}}_{t} = {θ}_{Refiner} ( Resample ( {e}_{t} , A l i g {n}_{RNN - T} ( {e}_{s} , t ) ) ) \qquad ( 1 )$$

Here, the upsampler 430 includes resampler and refiner layers that align the initial textual embedding 412 to align with a corresponding first higher order audio feature representation 205 (FIGS. 3C and 3D) directly. However, when paired training data is not available, the upsampler 430 generates the alignment output 402 as follows:

$${\hat{e}}_{t} = {θ}_{Refiner} ( Resample ( {e}_{t} , {θ}_{duration} ( {e}_{t} ) ) ) \qquad ( 2 )$$

In particular, the number of frames of the alignment output 402 indicates a predicted speech duration of the unspoken textual utterance 525 (or transcription 302). Stated differently, the number of frames of the alignment output 402 maps (i.e., aligns) the sequence of text chunks of the unspoken textual utterance 525 to speech frames. Here, the upsampler 430 includes resampler and refiner layers that replicate the initial textual embedding 412 to match the predicted text chunk duration 422 (i.e., speech duration). As such, the alignment output 402 includes a textual representation (e.g., tokenized sequence of sub-word units from the unspoken textual utterance 525) of the unspoken textual utterance 525 having a timing component that aligns with how a human would speak the unspoken textual utterance 525 in the target language. Optionally, the embedding extractor 410 may receive a language identifier 405 that uniquely identifies the target language of the corresponding unspoken textual utterance 525 or the corresponding transcription 302. As such, the alignment model 400 generates the alignment output 402 having a timing component that aligns with how a human would speak the unspoken textual utterance 525 in the respective one of the target languages.

Notably, in most instances, a text-to-speech (TTS) system generates an audible output to give the unspoken textual utterance 525 the timing component of human speech such that a training process may use the audible output from the TTS system (i.e., synthetic speech) to train the encoder 210. As discussed below, the training process 300 (FIGS. 3A-3D) may synthesize the unspoken textual utterances 525 in addition to, or in lieu of, using the alignment outputs 402 for training the ASR model 200. However, in contrast to synthesized speech from the TTS system, the alignment model 400 advantageously generates the alignment output 402 by mapping the sequence of text chunks to speech frames directly, without ever generating synthetic audible speech. As such, the training process 300 does not require, but may optionally include, the TTS system to generate synthetic speech from the unspoken textual utterances 525 to train the encoder 210.

Referring back to FIG. 3A, in some implementations, the encoder 210 includes a causal text encoder 202 and a causal speech encoder 204, described in more detail with reference to FIGS. 3B-3D. In the example shown, the audio encoder 210 (alternatively the causal text encoder 202 or the causal speech encoder 204 (FIGS. 3B-3D)) includes a Conformer encoder including a stack of Conformer blocks each of which includes a stack of multi-headed self-attention, depth wise convolution, and feed-forward layers. Alternatively, the encoder 210 may include another type of encoder having a stack of multi-head self-attention layers/blocks, such as a transformer or performer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each un-transcribed non-synthetic speech utterance 306, and generates, as output, for each of a plurality of output steps, an encoded audio feature 211 that corresponds to a respective one of the transcribed non-synthetic speech utterances 304 or a respective one of the un-transcribed non-synthetic speech utterances 306. The convolution subsampling block 212 may receive, as input, each alignment output 402 generated by the alignment model 400 from the unspoken textual utterances 525 and generate, as output, at each of the plurality of output steps, an encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receive the masked encoded features 211m, 213m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) k )}{{Σ}_{\tilde{q} ∼ {Q}_{t}} exp ( sim ( {c}_{t} , \tilde{q} ) / k )} \qquad ( 3 )$$

where cₜ is the contrastive context vector 215 centered over a masked output step (i.e., time step) t and qₜ represents a target context vector 219 at the output step t in a set of K+1 candidate target context vectors 219 which includes qₜ and K distractors. Distractors may be uniformly sampled from other masked output steps of the same utterance.

The contrastive loss 316 is optimized between the contrastive context vectors 215 at the masked positions and the target context vectors 219. After the encoder 210 converges on the un-transcribed non-synthetic speech utterances 306, the training procedure is repeated on both the alignment outputs 402 corresponding to the unspoken textual utterance 525 and the transcribed non-synthetic speech utterances 304. Thus, the contrastive loss 316 (L_{w2v}) is optimized for both real/human (non-synthetic) and unspoken textual utterances 525 represented by alignment outputs 402, with additional auxiliary losses derived from the transcribed non-synthetic speech utterances 304 and the alignment outputs 402 as described in greater detail below with reference to FIG. 3C. Accordingly, the contrastive loss part 300a of the training process 300 trains the encoder 210 using the contrastive loss 316 derived from the corresponding encoded features 211, 213 associated with each alignment output 402, each transcribed non-synthetic speech utterance 304, and each un-transcribed non-synthetic speech utterance 306 provided as input to the encoder 210. Training the encoder 210 may include updating parameters of the encoder 210 based on the contrastive losses 316.

Referring to FIG. 3B, the semi-supervised loss part 300b of the training process 300 is configured to inject lexical information into the encoder 210 during training based on the unpaired causal loss term 322 and the unpaired non-causal loss term 324 each derived from alignment outputs 402 output by the alignment model 400 and corresponding to the unspoken textual utterances 525 generated by the text generation process 500. The text generation process 500 employing the LLM 501 may generate the plurality of unspoken textual utterances 525 in a single target language and/or multiple target languages as code-mixed utterances for training the ASR model 200. Moreover, as described in greater detail below with reference to FIGS. 5-7, the fine-tuned prompt embedding 508 conditions the LLM 501 to generate output text 504 (FIGS. 5A and 5B) in the target language from the textual prompt 515 provided as input to the LLM 501, whereby the generated output text 504 and the textual prompt 515 are concatenated to form a corresponding unspoken textual utterance 525. In some examples, the encoder 210 of the ASR model 200 (FIG. 2) includes the causal text encoder 202 and a non-causal audio-text encoder (i.e., shared encoder) 206. Optionally, the causal text encoder 202 (also referred to as simply “text encoder 202”) may only be used during the training process 300 and not during inference of the ASR model 200. The causal text encoder 202 attends to the alignment outputs 402 in a causal manner such that the causal text encoder 202 does not receive any additional right-context (e.g., no additional frames of alignment output 402). In particular, the causal text encoder 202 is configured to receive alignment outputs 402 (i.e., text embeddings) from the alignment model 400 and generate, at each of a plurality of output steps, a first higher order textual feature representation 203 for a corresponding alignment output 402 (e.g., corresponding to an unspoken textual utterance 525). That is, the causal text encoder 202 operates in a streaming fashion such that, at each output step, the causal text encoder 202 outputs the first higher order textual feature representations 203 as soon as they are generated. Thus, the first higher order textual feature representations 203 may correspond to a portion of the alignment output 402 or an entirety of the alignment output 402.

The semi-supervised loss part 300b of the training process 300 employs a first-pass decoder 250 of the ASR model 200 (FIG. 2) configured to receive, as input, the first higher order textual feature representations 203 output from the causal text encoder 202 at each of the plurality of output steps and generate, as output, a first probability distribution 253 over possible text units for a corresponding first higher order textual feature representation 203. Here, each text unit from the first probability distribution 253 may include a wordpiece. In some implementations, the first-pass decoder 250 includes a RNN-T architecture. The first-pass decoder 250 may include a phoneme decoder configured to decode a sequence of phonemes, a wordpiece decoder configured to decode a sequence of word pieces, and/or a grapheme decoder configured to decode a sequence of graphemes. In some examples, the first probability distribution 253 over possible text units includes one of possible text labels, possible phoneme labels, possible wordpiece labels, or possible grapheme labels. An unpaired loss module 320 is configured to determine the unpaired causal loss term 322 based on the first probability distribution 253 over possible text units and the corresponding unspoken textual utterance 525. The unpaired causal loss term 322 may be represented by [symbol] (yₜ, xₜ) where yₜ represents the first probability distribution 253 over possible text units and xₜ represents the unspoken textual utterance 525. Here, the corresponding unspoken textual utterance 525 in which the first probability distribution 253 over possible text units is generated from, serves as a ground-truth transcription when determining the unpaired causal loss term 322 for the corresponding unspoken textual utterance 525.

With continued reference to FIG. 3B, the encoder 210 includes the non-causal audio-text encoder 206 configured to generate a second higher order textual feature representation 207 for a corresponding first higher order textual feature representation 203. As will become apparent, the non-causal audio-text encoder 206 generates higher order feature representations for text and audio encodings such that the training process 300 trains the encoder 210 using shared latent representations including speech and text modalities. The non-causal audio-text encoder 206 may include one of a plurality of unidirectional long short-term memory (LSTM) layers, a plurality of conformer layers, or a plurality of transformer layers. Notably, the non-causal audio-text encoder 206 operates in a non-streaming fashion such that the non-causal audio-text encoder 206 processes additional right context to generate the second higher order textual feature representations 207. That is, in contrast to the causal text encoder 202, the non-causal audio-text encoder 206 receives additional right context (e.g., additional frames of the alignment output 402) and generates the second higher order textual feature representation 207 by processing the additional right context. In some examples, the non-causal audio-text encoder 206 generates the second higher order textual feature representation 207 without receiving any alignment outputs 402 or audio data as input. In these examples, the non-causal audio-text encoder 206 only receives the first higher order textual feature representation 203 generated by the causal text encoder 202 at each of the plurality of output steps whereby the first higher order textual feature representations 203 represent the additional right context (e.g., 900 ms of additional right context frames). Accordingly, by processing the first higher order textual feature representation 203 corresponding to additional right context, the non-causal audio-text encoder 206 generates the second higher order textual feature representation 207 with more accuracy, but at the cost of increased latency.

The semi-supervised loss part 300b of the training process 300 includes the second-pass decoder 260 of the ASR model 200 (FIG. 2) configured to receive, as input, the second higher order textual feature representations 207 output by the non-causal audio-text encoder 206 and generate, as output, a second probability distribution 263 over possible text units for a corresponding second higher order textual feature representation 207. Here, each text unit from the first probability distribution 253 may include a wordpiece. In some examples, the first-pass decoder 250 and the second-pass decoder are the same decoder. In some implementations, the second-pass decoder 260 includes a RNN-T architecture. The second-pass decoder 260 may include a phoneme decoder configured to decode a sequence of phonemes, a wordpiece decoder configured to decode a sequence of word pieces, and/or a grapheme decoder configured to decode a sequence of graphemes. In some examples, the second probability distribution 263 over possible text units includes one of possible text labels, possible phoneme labels, possible wordpiece labels, or possible grapheme labels. Thus, the unpaired loss module 320 is further configured to determine the unpaired non-causal loss term 324 based on the second probability distribution 263 over possible text units and the corresponding unspoken textual utterance 525. The unpaired non-causal loss term 324 may be represented by [symbol] (yₜ, xₜ) where yₜ represents the second probability distribution 263 over possible text units and xₜ represents the unspoken textual utterance 525. Here, the corresponding unspoken textual utterance 525 in which the second probability distribution 263 over possible text units was generated from, serves as a ground-truth transcription for determining the unpaired non-causal loss term 324 for the corresponding unspoken textual utterance 525.

Thus, the semi-supervised loss part 300b of the training process 300 trains the encoder 210 of the ASR model 200 (FIG. 2) based on the unpaired loss terms 322, 324 derived from the unspoken textual utterances 525. Training the encoder 210 may include updating parameters of the causal text encoder 202 and/or the non-causal audio-text encoder 206 based on the unpaired loss terms 322, 324. Notably, the unpaired causal loss term 322 indicates a loss when the encoder 210 operates in the streaming fashion for the unspoken textual utterances 525 and the unpaired non-causal loss term 324 indicates a loss when the encoder 210 operates in the non-streaming fashion for the unspoken textual utterances 525. As such, the encoder 210 is jointly trained on the unpaired losses 322, 324 when the encoder 210 operates in the streaming and non-streaming modes.

Referring now to FIG. 3C, the supervised loss part 300c of the training process 300 is configured to inject lexical information into the encoder 210 during training based on a paired causal loss term 332 and a paired non-causal loss term 334 each derived from a corresponding transcribed speech utterance 304. In some examples, the encoder 210 includes a causal speech encoder 204 and the non-causal audio-text encoder 206 in addition to, or in lieu of, the text encoder 202 (FIG. 3B). In some examples, the causal speech encoder 204 (also referred to as simply “speech encoder 204”) includes one of a plurality of unidirectional long short-term memory (LSTM) layers, a plurality of conformer layers, or a plurality of transformer layers. In these examples, the causal speech encoder 204 may include an initial stack of conformer layers and the non-causal audio-text encoder includes a final stack of conformer layers overlain on the initial stack of conformer layers. The causal speech encoder 204 does not receive any additional right context (e.g., no additional frames of the transcribed speech utterance 304). In particular, the causal speech encoder 204 is configured to receive the transcribed speech utterances 304 and generate, at each of the plurality of output steps, a first higher order audio feature representation 205. That is, the causal speech encoder 204 operates in a streaming fashion such that, at each output step, the causal speech encoder 204 outputs the first higher order audio feature representations 205 as soon as they are generated. As such, the first higher order audio feature representation 205 may correspond to a portion of the transcribed speech utterance 304 or an entirety of the transcribed speech utterance 304.

The supervised loss part 300c of the training process 300 employs the first-pass decoder 250 and the second-pass decoder 260. The first-pass decoder 250 is configured to receive, as input, the first higher order audio feature representation 205 output from the causal speech encoder 204 at each of the plurality output steps and generate, as output at each of the plurality of output steps, a first probability distribution 255 over possible speech recognition hypotheses. In some implementations, the first-pass decoder 250 includes a RNN-T architecture. The first-pass decoder 250 may include a phoneme decoder configured to decode a sequence of phonemes, a wordpiece decoder configured to decode a sequence of word pieces, and/or a grapheme decoder configured to decode a sequence of graphemes. In some examples, the first probability distribution 255 over possible speech recognition hypotheses includes one of possible phoneme labels, possible wordpiece labels, or possible grapheme labels. Thereafter, a paired loss module 330 is configured to determine the paired causal loss term 332 based on the first probability distribution 255 over possible speech recognition hypotheses and the transcription 302 for the corresponding transcribed speech utterance 304. The paired causal loss term 332 may be represented by [symbol] (yₛ, xₛ) where yₛ represents the first probability distribution 255 over possible speech recognition hypotheses and xₛ represents transcribed speech utterance 304. Here, the transcription 302 paired with the corresponding transcribed speech utterance 304 in which the first probability distribution 255 over possible speech recognition hypotheses is generated from serves as a ground-truth transcription when determining the paired causal loss term 332 for the corresponding transcribed speech utterance 304.

With continued reference to FIG. 3C, the encoder 210 includes the non-causal audio-text encoder 206 configured to generate a second higher order audio feature representation 208 for a corresponding first higher order audio feature representation 205. That is, in contrast to the causal speech encoder 204, the non-causal audio-text encoder 206 receives additional right context (e.g., additional acoustic frames corresponding to the transcribed speech utterance 304) and generates the second higher order audio feature representation 208 by processing the additional right context. In some examples, the non-causal audio-text encoder 206 generates the second higher order audio feature representation 208 without receiving any additional transcribed speech utterances 304 or future acoustic frames. In these examples, the non-causal audio-text encoder 206 only receives the first higher order audio feature representation 205 generated by the causal speech encoder 204 at each of the plurality of output steps whereby the first higher order audio feature representations 205 represent the additional right context (e.g., 900 ms of additional right context frames). Accordingly, by processing the first higher order audio feature representation 205 corresponding to additional right context, the non-causal audio-text encoder 206 generates the second higher order audio feature representation 208 with more accuracy, but at the cost of increased latency.

The supervised loss part 300c of the training process 300 includes the second-pass decoder 260 of the ASR model 200 (FIG. 2) configured to receive, as input, the second higher order audio feature representations 208 output by the non-causal audio-text encoder 206 and generate, as output, a second probability distribution 265 over possible speech recognition hypotheses for a corresponding second higher order audio feature representation 208. In some implementations, the second-pass decoder 260 includes a RNN-T architecture. The second-pass decoder 260 may include a phoneme decoder configured to decode a sequence of phonemes, a wordpiece decoder configured to decode a sequence of word pieces, and/or a grapheme decoder configured to decode a sequence of graphemes. In some examples, the second probability distribution 265 over possible speech recognition hypotheses includes one of possible phoneme labels, possible wordpiece labels, or possible grapheme labels. Thus, the paired loss module 330 is further configured to determine the paired non-causal loss term 334 based on the second probability distribution 265 over possible speech recognition hypotheses and the transcription 302 of the corresponding transcribed speech utterance 304. The paired non-causal loss term 334 may be represented by [symbol] (yₛ, xₛ) where yₛ represents the second probability distribution 265 over possible speech recognition hypotheses and xₜ represents the transcribed speech utterance 304. Here, the transcription 302 of the corresponding transcribed speech utterance 304 from which second probability distribution 265 over possible speech recognition hypotheses was generated from, serves as a ground-truth transcription when determining the paired non-causal loss term 334 for the corresponding transcribed speech utterance 304.

Thus, the supervised loss part 300c of the training process 300 trains the encoder 210 of the ASR model 200 (FIG. 2) based on the paired loss terms 332, 334 derived from the transcribed speech utterances 304. Training the encoder 210 may include updating parameters of the causal speech encoder 204 and/or the non-causal audio-text encoder 206 based on the paired loss terms 332, 334. In some examples, the training process 300 trains the causal speech encoder 204 and the non-causal audio-text encoder 206 using Hybrid Autoregressive Transducer Factorization. Notably, the paired causal loss term 332 indicates a loss when the encoder 210 operates in the streaming fashion for transcribed speech utterances 304 and the paired non-causal loss term 334 indicates a loss when the encoder 210 operates in the non-streaming fashion for the transcribed speech utterances 304. As such, the encoder 210 is jointly trained on the paired losses 332, 334 when the encoder 210 operates in the streaming and non-streaming modes.

Referring to FIG. 3D, the consistency regularization part (i.e., modality matching part) 300d of the training process 300 is configured to promote the encoder 210 to learn consistent predictions between non-synthetic speech (e.g., real/human speech) and alignment outputs 402 by generating a consistent loss term ( [symbol] (θ)) 352 between training utterance pairs 301 that each include a corresponding one of the transcribed non-synthetic speech utterances (Xₛᵤₚ) 304 and a paired alignment output 404 of the same utterance as the corresponding transcribed non-synthetic speech utterance 304. As such, the transcribed non-synthetic speech utterance 304 and the paired alignment output 404 of each training utterance pair 301 is associated with a same ground-truth transcription 302. In short, the consistent loss term 352 between the transcribed non-synthetic speech utterance 304 and paired alignment output 404 of the same training utterance provides an unsupervised training aspect by encouraging the encoder 210 to behave consistently regardless of whether the training utterance belongs to non-synthetic speech (i.e., speech training data) or the alignment output (i.e., text training data) and independent of supervised loss terms between the ground-truth transcription 302 and each of: non-synthetic speech recognition hypotheses output by the auxiliary decoder 390; and speech recognition hypotheses output by the auxiliary decoder 390.

Similar to the alignment outputs 402 generated from the unspoken textual utterances 525 in FIG. 3B, the alignment model 400 may generate each paired alignment output 404 using the corresponding transcription 302 that is paired with transcribed non-synthetic speech utterance 304. Here, the non-synthetic speech utterance 304 is associated with paired alignment output 404 generated by the alignment model 400 mapping the corresponding transcription 302 into speech frames.

During the consistency regularization part 300d, the causal text encoder 202 receives, as input, each paired alignment output 404 and generates, as output, for each of the plurality of output steps, the first higher order textual feature representation 203 that corresponds to the paired alignment output 404 at the corresponding output step. The non-causal audio-text encoder 206 receives, as input, the first higher order textual feature representation 203 and generates, as output, the second higher order textual feature representation 207. The auxiliary decoder 390 including the phoneme decoder or the wordpiece decoder receives, as input, each second higher order textual feature representation 207 from the non-causal audio-text encoder 206 and generates, as output, a first probability distribution 311 over possible speech recognition hypotheses for the corresponding paired alignment output 404 at the corresponding output step. In some examples, the first probability distribution 311 over possible speech recognition hypotheses includes one of possible phoneme labels or possible word piece labels.

Similarly, the causal speech encoder 204 receives, as input, each transcribed non-synthetic speech utterance 304 as a sequence of features/vectors (e.g., mel-frequency spectrograms such as the acoustic frames 110 of FIG. 1) and generates, as output, for each of a plurality of output steps, the first higher order audio feature representation 205 that corresponds to the transcribed non-synthetic speech utterance 304 at the corresponding output step. The non-causal audio-text encoder 206 receives, as input, the first higher order audio feature representation 205 and generates, as output, the second higher order audio feature representation 208. The auxiliary decoder 390 including the phoneme decoder or the wordpiece decoder receives, as input, each second higher order audio feature representation 208 output from the non-causal audio-text encoder 206 and generates, as output, a second probability distribution 394 over possible non-synthetic speech recognition hypotheses for the corresponding transcribed non-synthetic speech utterance 304 at the corresponding time step. In some examples, the second probability distribution 394 over possible non-synthetic speech recognition hypotheses includes the one of the possible phoneme labels or the possible word piece labels.

With continued reference to FIG. 3D, the consistency regularization part 300d of the training process 300 further determines, at each of the plurality of output steps for each training utterance pair 301, the consistent loss term ( [symbol] (θ)) 352 for the corresponding training utterance pair 301 based on the first probability distribution 311 over possible speech recognition hypotheses and the second probability distribution 394 over possible non-synthetic speech recognition hypotheses. For instance, the training process 300 may employ a consistency loss term module 350 configured to receive, at each output step, the corresponding first and second probability distributions 311, 394 output by the auxiliary decoder 390, and determine the consistency loss term 352 for the corresponding training utterance pair 301 at the time step. For example, the consistency loss term module 350 may compare the first and second probability distributions 311, 394 to determine the consistency loss term 352.

In some examples, the consistency regularization part 300d of the training process 300 determines the consistent loss term 352 based on a Kullback-Leibler divergence (D_{KL}) between the first probability distribution 311 over possible speech recognition hypotheses and the second probability distribution 394 over possible non-synthetic speech recognition hypotheses. The consistent loss term 352 based on D_{KL} may be expressed by the following equation:

$${𝒥}_{cons} ( θ ) = {𝒟}_{KL} ( {p}_{\tilde{θ}} ( y \vert x ) \vert \vert {p}_{θ} ( y \vert \hat{x} ) ) \qquad ( 4 )$$

Here, the consistent loss term 352 determined for the training utterance pair 301 at each time step provides an “unsupervised” loss term that is independent of the accuracy of the auxiliary decoder 390 (e.g., independent of the semi-supervised loss terms 322, 324 and supervised loss terms 332, 334 of FIGS. 3B and 3C), and thus, may be employed to update parameters of the encoder 210 for promoting consistency between non-synthetic speech representations and alignment outputs of the same utterances. In batch training, the consistent loss term 352 may correspond to an average loss term obtained for the batch. In other words, the consistent loss term 352 permits the encoder 210 to learn to behave the same (e.g., make consistent encoded representation predictions) on both non-synthetic speech (e.g., real/human speech) and alignment outputs of a same training utterance, regardless of whether the training utterance belongs to non-synthetic speech or alignment outputs.

Lastly, the training process 300 may combine the unpaired data loss function ( [symbol] ), the paired data loss function ( [symbol] ), and the consistent loss term ( [symbol] ) to obtain an overall loss term, [symbol] , that may be expressed as follows.

$${𝒥}_{tts 4 pretrain 2} = {𝒥}_{unpaired} + {λ}_{1} 𝒥paired + {λ}_{2} {𝒥}_{c o n s} \qquad ( 5 )$$

where λ₁ may be equal to 1.0 and λ₂ is equal to 0.1. The training process 300 may pre-train the encoder 210 using the overall loss term, [symbol] , by updating parameters of the encoder 210 to effectively teach the encoder 210 to learn shared representations between speech and text in the target language even though no labeled training data in the target language may be available. After training the encoder 210, the training process 300 may fine-tune the pre-trained encoder on transcribed speech utterances that may include supervised training samples of both alignment outputs corresponding to unspoken textual utterance 525 and non-synthetic (e.g., human speech).

Implementations described above describe the training process 300 training the training the encoder 210 for a target language, however, it is understood that the training process 300 may also be employed to train the encoder for multiple target languages each different from the one or more training languages and/or train the encoder for a code-mixed target language. In some instances, the training process 300 may be employed to train end-to-end ASR models with decoder structures (i.e., non-pre-training) or fine-tune an ASR model to perform downstream tasks such as speech translation or natural language understanding. Moreover, implementations described above describe the training process using each part 300a-d of the training process 300. Yet, it is understood any combination of the training parts 300a-d may be used to train the encoder 210 using any combination of unspoken textual utterances 525, transcribed non-synthetic speech utterances 304, and/or untranscribed non-synthetic speech utterances 306 independently. Moreover, the training process 300 may use a text-to-speech model (not shown) to generate synthesized speech from the unspoken textual utterances 525 generated by the LLM 501. The training process 300 may incorporate the synthesized speech as transcribed speech utterances 304 and/or un-transcribed speech utterances 306 to train the ASR model 200. In particular, the training process may leverage the synthesized speech to determine consistency losses between synthesized and non-synthesized speech and SimCLR or contrastive losses.

FIGS. 5A and 5B each illustrate an example text generation process 500 that employs the LLM 501 for generating the plurality of unspoken textual utterances 525. More specifically, FIG. 5A illustrates a monolingual text generation process 500, 500a for generating unspoken textual utterances 525 each including monolingual text (i.e., text that includes a single language) in a particular language. In some examples, the unspoken textual utterances 525 generated by the monolingual text generation process 500a include monolingual text utterances spanning multiple different languages. For instance, a first group of unspoken textual utterances 525 may each include monolingual text in English, a second group of unspoken textual utterances 525 may each include monolingual text in Mandarin, a third group of unspoken textual utterances 525 may include monolingual text in Spanish, and so on. As such, the unspoken textual utterances 525 include monolingual text across multiple different languages such that the training process (FIGS. 3A-3D) can use the unspoken textual utterances 525 generated by the monolingual text generation process 500a to train a monolingual ASR model to learn to recognize speech spoken in each of the multiple different languages.

On the other hand, FIG. 5B illustrates a code-mixed text generation process 500, 500b (FIG. 5B) for generating unspoken textual utterances 525 that each include code-mixed text (i.e., each including text from two or more languages) that forms a complete sentence (or paragraph). Thus, each unspoken textual utterance 525 generated by the code-mixed text generation process 500b includes code-mixed (i.e., code-switched) text such that the training process 300 (FIG. 3) can use the unspoken textual utterances 525 to train the multi-lingual ASR model to recognize code-mixed speech. The multi-lingual ASR model 200, when trained on code-mixed textual utterances 525, may be referred to as a code-mixed ASR model 200 capable of recognizing code-mixed speech.

Referring now to the monolingual text generation process 500a of FIG. 5A, in some implementations, the LLM 501 is configured to receive, as input, the fine-tuned prompt embedding 508 and the textual prompt 515 in the first language and generate, as output, output text 504 in the target language. Here, the target language includes the first language, i.e., the fine-tuned prompt embedding 508 conditions the LLM 501 to generate output text 504 in the same language as the textual prompt 515. In some examples, the textual prompt 515 includes a prefix of a seed sentence 512 in the first language where the monolingual text generation process 500a samples the seed sentence from a set of multilingual seed sentences 510. Here, the set of multilingual seed sentences 510 includes a plurality of monolingual seed sentence subsets 512, 512a-n each including corresponding seed sentences in a respective language different than the respective language of the corresponding seed sentences of each other monolingual seed sentence subset. The total number of seed sentences across the plurality of monolingual seed sentence subsets 512, 512a-n may include about 1.3 million sentences. In some examples, the plurality of monolingual seed sentence subsets 512 includes a total of 12 subsets each corresponding to a respective one of 12 different languages. The languages may include, without limitation, English, Mandarin, French, German, Japanese, Spanish (USA), Spanish (Spain), Arabic, Italian, Hindi, Portuguese, and Russian.

For instance, in the example shown, the plurality of monolingual seed sentence subsets 512 includes a first monolingual seed sentence subset 512, 512a including corresponding seed sentences in English and a second monolingual seed sentence subset 512, 512b including corresponding seed sentences in French, however, it is understood that any number of monolingual seed sentence subsets 512 may be included in the set of multilingual seed sentences 510. Moreover, the first monolingual seed sentence subset 512a includes a plurality of monolingual seed sentences in English and the second monolingual seed sentence subset 512b includes a plurality of monolingual seed sentences in French. The monolingual text generation process 500a may obtain the textual prompt 515 by sampling from the set of multilingual seed sentences 510. In particular, the textual prompt 515 includes the prefix from a respective one of the seed sentences. The prefix may only include a portion (e.g., one-quarter or one-half) of the sampled seed sentence. In some examples, the prefix length is randomly chosen between four (4) tokens (e.g., words/terms) and half of the length of the seed sentence. Additionally or alternatively, the output text 504 generated by the LLM 501 is constrained to a max length of 62 tokens. A top-N most probable tokens of output text 504 may be sampled to provide lexical diversity.

Continuing with the example shown, the monolingual text generation process 500a samples the seed sentence of “No stopping over at Tokyo it is my own choice” from the first monolingual seed sentence subset 512a (e.g., English seed sentence subset) and selects the prefix of “No stopping over at Tokyo” from the seed sentence as the textual prompt 515 in the first language. Thus, the textual prompt 515 does not include the portion “it is my own choice” from the seed sentence. Notably, although not shown, any number of subsequent seed sentences sampled by the monolingual text generation process 500a may include seed sentences from other subsets 512 such as the second monolingual seed sentence subset 512b (e.g., French seed sentence subset), thereby enabling the monolingual text generation process 500a to sample textual prompts 515 across multiple different languages.

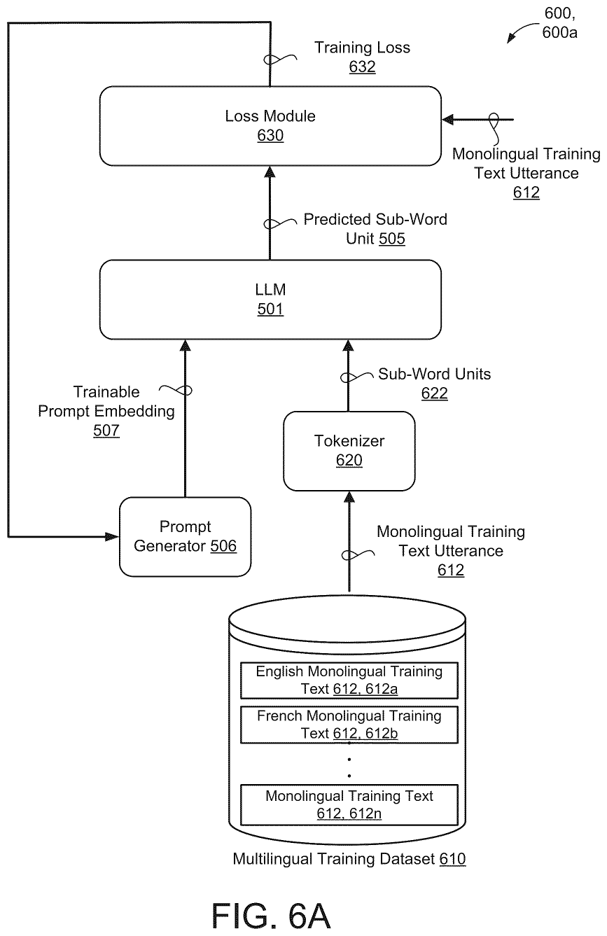

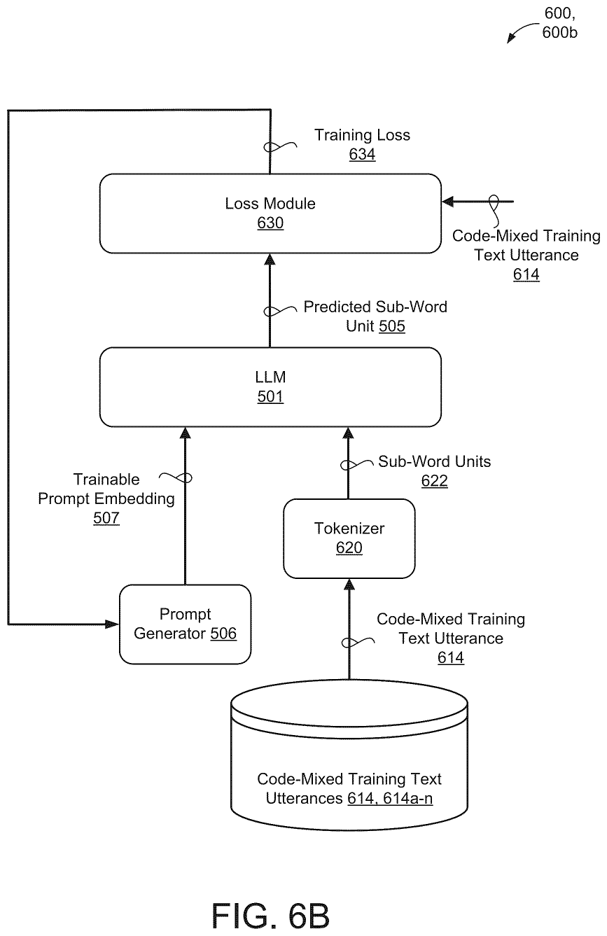

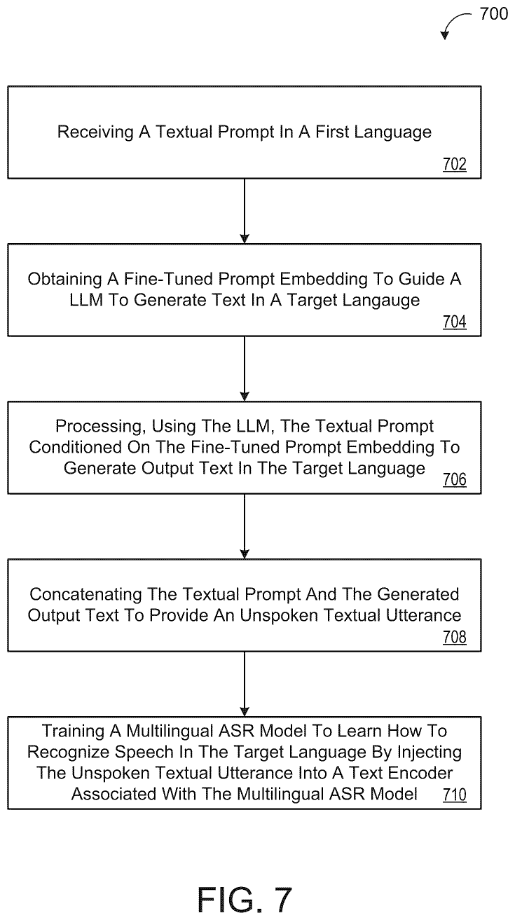

The fine-tuned prompt embedding 508 received by the LLM 501 is configured to guide the LLM 501 to generate text in the same language as the textual prompt 515 input to the LLM 501. Described in greater detail with reference to FIGS. 6 and 7, the fine-tuned prompt embedding 508 includes a pre-trained embedding. Continuing with the example shown, the LLM 501 receives the fine-tuned prompt embedding 508 and the textual prompt 515 in the first language corresponding to “No stopping over at Tokyo” and generates the output text 504 of “I mean it” in the target language. Here, the output text 504 is generated as monolingual text in the same language as the textual prompt 515.

In some implementations, the monolingual text generation process 500a employs a concatenator 520 configured to concatenate the textual prompt 515 and the generated output text 504 to provide the unspoken textual utterance 525. Continuing with the example above, the concatenator 520 forms the unspoken textual utterance 525 of “No stopping over at Tokyo I mean it” by concatenating the textual prompt 515 corresponding to the prefix of the sampled seed sentence and the output text 505 generated as output from the LLM 501. In this example, the portion of the unspoken textual utterance 525 corresponding to the output text 504 of “I mean it” is lexically different from the corresponding portion of the sampled seed sentence of “it is my own choice.” As such, the unspoken textual utterance 525 adds lexical diversity for training utterances to train the ASR model. The output text 504 is not a translation of the textual prompt 515 input to the LLM 501.

The monolingual text generation training process 500a of FIG. 5A will similarly generate unspoken textual utterances in each other language in a similar fashion. For example, another textual prompt 515 may include a prefix selected from a seed sentence sampled from the French monolingual subset 512b, whereby the LLM 501 receives the other textual prompt 515 in French and the same fine-tuned prompt embedding 508 as input to generate, as output, new output text 504 in French such that an unspoken textual utterance in French can be formed by concatenating the textual prompt 515 in French with the new output text 504 generated in French. While not shown, the process 500a may employ a filtering step to remove duplicate sentences and sentences not ending properly (i.e., ending without an end-of-sentence label). The process 500a may generate about 20 million unspoken textual utterances 515.

In short, the LLM 501 increases the lexical diversity of training textual data by generating output text 504 that forms the unspoken textual utterance 525 where, notably, the unspoken textual utterance 525 is a coherent and intelligible utterance. That is, because the fine-tuned prompt embedding 508 guides the LLM 501 to generate output text 504 in a same language as the textual prompt 515 input to the LLM 501, the resulting unspoken textual utterance 525 includes a sequence of text that a real person is likely to actually speak. Stated differently, the LLM 501 is not simply generating the output text 504 randomly or unintelligibly for the received textual prompts 515. For example, generating output text 504 of “taste is not very delicious” for the textual prompt 515 “no stopping over at Tokyo” results in an unspoken textual utterance 525 that does increase lexical diversity of the training data, but no real person is likely to ever speak this utterance. Simply put, generating unspoken textual utterances 525 that are likely to actually be spoken by a user has much more training value than generating unintelligible training utterances.

Referring now to the code-mixed text generation process 500b of FIG. 5B, in some implementations, the LLM 501 receives, as input, the fine-tuned prompt embedding 508 and the textual prompt 515 in the first language and generates, as output, the output text 504 in the target language. Here, the target language includes a second language different than the first language, i.e., the fine-tuned prompt embedding 508 conditions the LLM 501 to generate output text 504 that includes at least one word in a different language than the language of the words in the textual prompt 515. Notably, while the fine-tuned prompt embedding 508 used by the monolingual text generation process 500b is fine-tuned for conditioning the LLM 501 to generate output text 504 in the same language as the textual prompt 515, the fine-tuned prompt embedding 508 used by the code-mixed text generation process 500b is fine-tuned for conditioning the LLM 501 to generate output text 508 in one or more different languages than the textual prompt. In some examples, the textual prompt 515 includes a prefix of a seed sentence in the first language where the code-mixed text generation process 500b samples the seed sentence from a set of code-mixed seed sentences 514. Here, each code-mixed seed sentence 514 from the set of code-mixed seed sentences 514 includes corresponding code-mixed text in both the first language and the second language. In the example shown, the code-mixed text generation process 500b samples a code-mixed seed sentence 514 of “I spend [symbol] [symbol] ” that includes words/text in English and words/text in Mandarin and selects the prefix of the seed sentence of “I spend” as the textual prompt 514. Here, the code-mixed seed sentence 514 translates to “I spend too much time erasing.”

The fine-tuned prompt embedding 508 received by the LLM 501 is configured to guide the LLM 501 to generate text in the target language (e.g., target language for training the ASR model 200) from the textual prompt 515 in the first language. Described in greater detail with reference to FIGS. 6 and 7, the fine-tuned prompt embedding 508 includes a pre-trained embedding. Continuing with the example shown, the LLM 501 receives the fine-tuned prompt embedding 508 and the textual prompt 515 in the first language corresponding to “I spend” and generates the output text 504 in the second language of “ [symbol] ” which translates to “too much money I don't want to buy it.” The code-mixed text generation process 500b employs the concatenator 520 that concatenates the output text 504 with the textual prompt 515 to provide the unspoken textual utterance 525. Continuing with the example above, the concatenator 520 generates the unspoken textual utterance 525 of “I spend [symbol] ” which translates to “I spend too much money I don't want to buy it.” In this example, the portion of the unspoken textual utterance 525 corresponding to the output text 504 of “ [symbol] [symbol] ” (e.g., too much money I don't want to buy it) is in the second language different than the first language of the textual prompt 515 and is different from the corresponding portion of the sampled code-mixed seed sentence of “ [symbol] ” (e.g., too much time erasing). As such, the unspoken textual utterance 525 adds lexical diversity for training utterances used to train the ASR model 200 (FIGS. 2, 3A, and 3B).

In short, the LLM 501 increases the lexical diversity of training textual data by generating the unspoken textual utterance 525 where, notably, the unspoken textual utterance 525 is a coherent and intelligible utterance that code-mixes words/terms across at least two different languages, e.g. English and Mandarin. That is, because the fine-tuned prompt embedding 508 guides the LLM 501 to generate output text 504 in the target language in a rational manner based on the textual prompt 515, the resulting unspoken textual utterance 525 includes a sequence of text that a real person (e.g., a real person that speaks in a code-mixed manner) is likely to actually speak. Stated differently, the LLM 501 is not simply generating the output text 504 randomly or unintelligibly for the textual prompts 515. Simply put, generating unspoken textual utterances 525 that are likely to actually be spoken by a user have much more training value than unintelligible training utterances.

The example shown in FIG. 5B includes a monolingual prefix in the first language (e.g., English) and monolingual output text 503 in the second language (e.g., Mandarin) that when concatenated, form a code-mixed textual utterance 515. However, in some examples, the code-mixed text generation process 500b samples the prefix from the code-mixed seed sentence such that the prefix includes text in both the first language and the second language and the output text 504 generated by the LLM 501 includes words/terms in one of the first language or the second languages or both of the first language and the second language. While the example of FIG. 5B only depicts the set of code-mixed seed sentences 514 including seed sentences in both the first language and the second language, the set of code-mixed seed sentences 514 may encompass multiple code-mixed seed sentence subsets 514a-n whereby each code-mixed seed sentence subset 514a-n includes one or more code-mixed seed sentences in a respective combination of two or more languages different than the respective combination of the two or more languages of the code-mixed seed sentences in each other code-mixed seed sentence subset 514a-n. For instance, a first code-mixed seed sentence subset 514a may include the code-mixed seed sentences 514 in English and Mandarin and a second code-mixed seed sentence subset 514a may include codemixed seed sentences 514 in English and Spanish. Notably, a respective fine-tuned prompt embedding 508 may be fine-tuned for each respective code-mixed seed sentence subset 514a-n. For instance, and continuing with the example, a first fine-tuned prompt embedding 508 may condition the LLM 501 to generate output text in Mandarin from a textual prompt 514 that corresponds to an English prefix sampled from the first code-mixed seed sentence subset 514a, while a second fine-tuned prompt embedding 508 may condition the LLM 501 to generate output text in Spanish from a textual prompt 514 that corresponds to an English prefix sampled from the second code-mixed seed sentence subset 514b.

FIGS. 6A and 6B each illustrate an example fine-tuning process 600 that tunes/trains the fine-tuned prompt embedding 508 configured to guide the LLM 501 to generate text in the target language based on the textual prompt 515. The LLM 501 is a pre-trained LLM that is pre-trained on a diverse range of text data sourced from, but not limited to, web documents, books, and code. Parameters of the LLM 501 are frozen and not updated during the fine-tuning process 600. In some scenarios, certain text prompts can be added to textual inputs of LLMs to condition the LLMs to perform different tasks through “in-context” learning. However, these text prompts require a user to hand-craft text prompts for the task at hand requiring a tremendous amount of manual user involvement. Accordingly, scaling the use of text prompts is not feasible due to the amount of user involvement required. To that end, the fine-tuning process 600 trains a trainable prompt embedding 507 (i.e., soft-prompt) that guides the LLM 501 in a similar manner. In particular, a monolingual fine-tuning process 600, 600a (FIG. 6A) trains the training prompt embedding 507 to generate the fine-tuned prompt embedding 508 used by the monolingual text generation process 500a (FIG. 5A) and a code-mixed fine-tuning process 600, 600b (FIG. 6B) trains the training prompt embedding 507 to generate the fine-tuned prompt embedding 508 used by the code-mixed text generation process 500b (FIG. 5B). Advantageously, the trainable prompt embedding 507 requires little (or no) user involvement and can easily be scaled across a plurality of different tasks without ever having to update parameters of the LLM 501.

Referring now to FIG. 6A, in some implementations, the monolingual fine-tuning process 600a generates the fine-tuned prompt embedding 508 (FIG. 5A) by obtaining a randomly initialized trainable prompt embedding 507 from a prompt generator 506. The trainable prompt embedding 507 may include a predetermined number of tunable vector embeddings and includes a dimension equal to an input dimension of the LLM 501. For example, the predetermined number of tunable vector embeddings may be equal to 100. Moreover, the monolingual fine-tuning process 600a obtains a multilingual training dataset 610 that includes a plurality of training data subsets 612, 612a-n. Here, each training data subset 612 includes corresponding monolingual training text utterances in a respective language that is different than the respective language of the corresponding monolingual training text utterances included in each other training data subset 612. For instance, in the example shown, the plurality of training data subsets 612 includes a first training data subset 612, 612a including corresponding training text utterances in English and a second training data subset 612, 612b including corresponding seed sentences in French, however, it is understood that any number of training data subsets 612 may be included in the multilingual training dataset 610. Moreover, the first training data subset 612a includes a plurality of training text utterances in English and the second training data subset 612b includes a plurality of training text utterances in French. In some examples, each training data subset 612 includes one or more corresponding transcribed speech utterances (e.g., transcribed speech utterances 304 (FIGS. 3A-3D) represented by a corresponding sequence of acoustic frames and paired with a corresponding transcription 302 represented by a corresponding one of the monolingual training text utterances in the corresponding training data subset 612. That is, each training data subset 612 may include transcribed speech utterances 304 used by the training process 300 (FIGS. 3A-3D).

For each monolingual training text utterance 612, a tokenizer 620 tokenizes the monolingual training text utterance 612 into a sequence of corresponding sub-word units 622 (e.g., words, wordpieces, graphemes, etc.). Thereafter, the LLM 501 processes the sequence of corresponding sub-word units 622 to determine a first training loss 632 that maximizes a probability of predicting a next-sub word unit 622 based on each of the preceding sub-word units 622 in the sequence of sub-word units 622. That is, for each sub-word unit 622 in the sequence of sub-word units 622, the LLM 501 outputs a predicted sub-word unit 505 indicating a prediction for the next sub-word unit 622 in the sequence of sub-word units 622. In some examples, the LLM 502 generates the predicted sub-word unit 505 for each sub-word unit based on the one or more preceding sub-word units 622 from the sequence of sub-word units 622. Moreover, a loss module 630 determines the first training loss 632 for each sub-word unit 622 and back-propagates the first training loss 632 to the prompt generator 506 for fine-tuning the randomly initialized training prompt embedding 507 while the parameters of the LLM 501 are kept fixed or frozen. In particular, the loss module 630 may determine the first training loss 632 by comparing the predicted sub-word units 505 generated by the LLM 501 with the monolingual training text utterance 612 (i.e., ground truth label) that the predicted sub-word unit 505 was generated from. Thus, the monolingual fine-tuning process 600a may fine-tune the randomly initialized trainable prompt embedding 507 based on the training loss 632 generated for each sub-word unit 622. More specifically, the monolingual fine-tuning process 600a may fine-tune the randomly initialized trainable prompt embedding 507 by updating parameters of the prompt embedding 507. As used herein, updating parameters of the prompt embedding 507 based on the training losses 632 includes tuning/updating values of the predetermined number of tunable vector embeddings of the trainable prompt embedding 507. The fine-tuning of the randomly initialized trainable prompt embedding 507 on the first training loss 632 for each training text utterance 612 by the monolingual fine-tuning process 600a provides the fine-tuned prompt embedding 508 that is used by the monolingual text generation process 500a (FIG. 5A).

Referring now to FIG. 6B, in some implementations, the code-mixed fine-tuning process 600b generates the fine-tuned prompt embedding 508 (FIG. 5B) by obtaining a randomly initialized trainable prompt embedding 507 from the prompt generator 506. The trainable prompt embedding 507 may include a predetermined number of tunable vector embeddings and includes a dimension equal to an input dimension of the LLM 501. For example, the predetermined number of tunable vector embeddings may be equal to 100. Moreover, the code-mixed fine-tuning process 600b obtains a code-mixed training dataset 614 that includes a plurality of code-mixed training text utterances 614, 614a-n. Here, each code-mixed training text utterance 614 includes code-mixed text in the first language and the second language. In some examples, the code-mixed training dataset 614 includes one or more corresponding transcribed speech utterances (e.g., transcribed speech utterances 304 (FIGS. 3A-3D) represented by a corresponding sequence of acoustic frames and paired with a corresponding transcription 302 represented by a corresponding one of the code-mixed training text utterances in the corresponding code-mixed training data subset 614. That is, the code-mixed training dataset 614 may include transcribed speech utterances 304 used by the training process 300 (FIGS. 3A-3D).

For each code-mixed training text utterance 614, the tokenizer 620 tokenizes the code-mixed training text utterance 614 into a sequence of corresponding sub-word units 622 (e.g., words, wordpieces, graphemes, etc.). Thereafter, the LLM 501 processes the sequence of corresponding sub-word units 622 to determine a second training loss 634 that maximizes a probability of predicting a next-sub word unit 622 based on each of the preceding sub-word units 622 in the sequence of sub-word units 622. That is, for each sub-word unit 622 in the sequence of sub-word units 622, the LLM 501 outputs a predicted sub-word unit 505 indicating a prediction for the next sub-word unit 622 in the sequence of sub-word units 622. In some examples, the LLM 502 generates the predicted sub-word unit 50S for each sub-word unit based on the one or more preceding sub-word units 622 from the sequence of sub-word units 622. Moreover, the loss module 630 determines the second training loss 634 for each sub-word unit 622 and back-propagates the second training loss 634 to the prompt generator 506 for tuning the randomly initialized training prompt embedding 507 while the parameters of the LLM 501 are kept fixed or frozen. In particular, the loss module 630 may determine the second training loss 634 by comparing the predicted sub-word unit 505 generated by the LLM 501 with the code-mixed training text utterance 614 (i.e., ground truth label) that the predicted sub-word unit 505 was generated from. That is, the code-mixed fine-tuning process 600b may fine-tune the randomly initialized trainable prompt embedding 507 based on the second training loss 634 generated for each sub-word unit 622. More specifically, the code-mixed fine-tuning process 600b may fine-tune the randomly initialized trainable prompt embedding 507 by updating parameters of the trainable prompt embedding 507. As used herein, updating parameters of the prompt embedding 507 based on the training losses 632 includes tuning/updating values of the predetermined number of tunable vector embeddings of the trainable prompt embedding 507. The fine-tuning of the randomly initialized trainable prompt embedding 507 on the second training loss 634 for each training text utterance 614 by the code-mixed fine-tuning process 600b provides the fine-tuned prompt embedding 508 that is used by the code-mixed text generation process 500b (FIG. 5B).

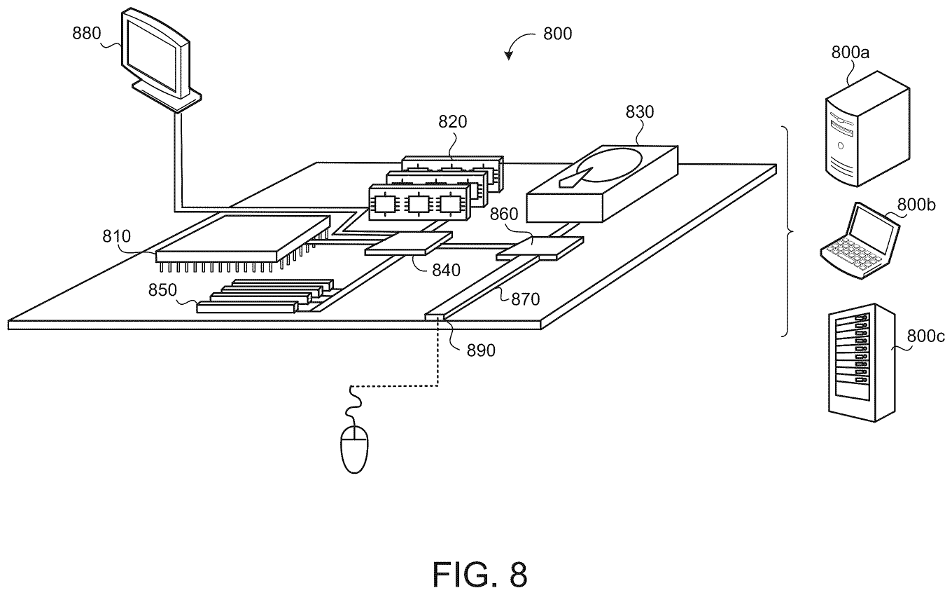

FIG. 7 is a flowchart of an example arrangement of operations for a computer-implemented method 700 of training multilingual and code-switching ASR using LLM generated text. The method 700 may execute on data processing hardware 810 (FIG. 8) using instructions stored on memory hardware 820 (FIG. 8). The data processing hardware 810 and the memory hardware 820 may reside on the user device 10 and/or the remote computer/server 60 of FIG. 1 corresponding to a computing device 800 (FIG. 8).

At operation 702, the method 700 includes receiving a textual prompt 515 in a first language. At operation 704, the method 700 includes obtaining a fine-tuned prompt embedding 508 configured to guide the LLM 501 to generate text in a target language from textual prompts 515 in the first language. At operation 706, the method 700 includes processing, using the LLM 501, the textual prompt 515 conditioned on the fine-tuned prompt embedding 508 to generate output text 504 in the target language. In some examples, the output text 504 includes monolingual text (FIG. 5A) in the same or different language than the first language of the textual prompt 515. In other examples, the output text 504 includes code-switched text (FIG. 5B) including two or more different languages. At operation 708, the method 700 includes concatenating the textual prompt 515 and the generated output text 504 to provide an unspoken textual utterance 525. At operation 710, the method 700 includes training a multilingual ASR model 200 to learn how to recognize speech in the target language by injecting the unspoken textual utterance into a text encoder 202 associated with the multilingual ASR model 200.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a textual prompt in a first language;
obtaining a fine-tuned prompt embedding configured to guide a large language model (LLM) to generate text in a target language from textual prompts in the first language;
processing, using the LLM, the textual prompt conditioned on the fine-tuned prompt embedding to generate output text in the target language;
concatenating the textual prompt and the generated output text to provide an unspoken textual utterance; and
training a multilingual automatic speech recognition (ASR) model to learn how to recognize speech in the target language by injecting the unspoken textual utterance into a text encoder associated with the multilingual ASR model.

2. The computer-implemented method of claim 1, wherein the output text generated in the target language comprises monolingual text in the first language.

3. The computer-implemented method of claim 2, wherein the textual prompt comprises a prefix of a seed sentence in the first language, the seed sentence sampled from a set of multilingual seed sentences, the set of multilingual seed sentences comprising a plurality of monolingual seed sentence subsets, each monolingual seed sentence subset comprising corresponding seed sentences in a respective language different than the respective language of the corresponding seed sentences of each other monolingual seed sentence subset.

4. The computer-implemented method of claim 2, wherein the fine-tuned prompt embedding is learned during a fine-tuning process by:
obtaining a randomly initialized trainable prompt embedding;
obtaining a multilingual training dataset comprising a plurality of training data subsets, each training data subset including corresponding monolingual training text utterances in a respective language that is different than the respective language of the corresponding monolingual training text utterances included in each other training data subset;
for each monolingual training text utterance:
tokenizing the monolingual training utterance into a sequence of corresponding sub-word units; and
processing, using the LLM, the sequence of corresponding sub-word units to determine a training loss that maximizes a probability of predicting a next sub-word unit based on each of the preceding sub-word units in the sequence of sub-word units; and
fine-tuning, using the training losses, the randomly initialized trainable prompt embedding while parameters of the LLM are kept fixed.

5. The computer-implemented method of claim 4, wherein:
each corresponding training data subset of the plurality of training data subsets comprises one or more corresponding transcribed speech utterances each represented by a corresponding sequence of acoustic frames and paired with a corresponding transcription represented by a corresponding one of the monolingual training text utterances in the corresponding training data subset; and
training the multilingual speech recognition model further comprises training the multilingual speech recognition model on each of the one or more corresponding transcribed speech utterances in each corresponding training data subset of the plurality of training data subsets.

6. The computer-implemented method of claim 1, wherein the output text generated in the target language comprises text in a second language different than the first language.

7. The computer-implemented method of claim 6, wherein the textual prompt comprises a prefix of a seed sentence in the first language, the seed sentence sampled from a set of code-mixed seed sentences, each code-mixed seed sentence comprising corresponding code-mixed text in both the first language and the second language.

8. The computer-implemented method of claim 6, wherein the fine-tuned prompt embedding is learned during a fine-tuning process by:
obtaining a randomly initialized trainable prompt embedding;
obtaining a code-mixed training dataset comprising a plurality of code-mixed training text utterances that each comprise code-mixed text in the first language and the second language;
for each code-mixed training text utterance:
tokenizing the code-mixed training text utterance into a sequence of corresponding sub-word units; and
processing, using the LLM, the sequence of corresponding sub-word units to determine a training loss that maximizes a probability of predicting a next sub-word unit based on each of the preceding sub-word units in the sequence of sub-word units; and
fine-tuning, using the training losses, the randomly initialized trainable prompt embedding while parameters of the LLM are kept fixed.

9. The computer-implemented method of claim 8, wherein:
the code-mixed training dataset comprises one or more corresponding transcribed code-mixed speech utterances each represented by a corresponding sequence of acoustic frames and paired with a corresponding transcription represented by a corresponding one of the code-mixed training text utterances; and
training the multilingual speech recognition model further comprises training the multilingual speech recognition model on each of the one or more corresponding transcribed code-mixed speech utterances in the code-mixed training dataset.

10. The computer-implemented method of claim 1, wherein the LLM is pre-trained on a diverse range of text data sourced from web documents, books, and code.

11. The computer-implemented method of claim 1, wherein training the multilingual ASR model to learn how to recognize speech in the target language by injecting the unspoken textual utterance into the text encoder associated with the multilingual ASR model comprises:
tokenizing the unspoken textual utterance into a sequence of sub-word units;
generating, by the text encoder of an encoder, at each of a plurality of output steps, a first higher order textual feature representation for a corresponding sub-word unit in the sequence of sub-word units tokenized from the unspoken textual utterance;
receiving, as input to a first-pass decoder, the first higher order textual feature representation generated by the text encoder at each of the plurality of output steps; and
generating, by the first-pass decoder, at each of the plurality of output steps, a first probability distribution over possible text units; and
training the encoder based on the first probability distribution over possible text units generated by the first-pass decoder at each of the plurality of output steps for the unspoken textual utterance.

12. The computer-implemented method of claim 11, wherein the operations further comprise:
receiving, as input to a non-causal audio-text encoder of the encoder, the first higher order textual feature representation generated by the text encoder at each of the plurality of output steps;
generating, by the non-causal audio-text encoder, at each of the plurality of output steps, a second higher order textual feature representation for a corresponding first higher order textual feature representation;
receiving, as input to a second-pass decoder, the second higher order textual feature representation generated by the non-causal audio-text encoder at each of the plurality of output steps; and
generating, by the second decoder, at each of the plurality of output steps, a second probability distribution over possible text units,
wherein training the encoder is further based on the second probability distribution over possible text units generated by the second-pass decoder at each of the plurality of output steps for the unspoken textual utterance.

13. The computer-implemented method of claim 12, wherein the first-pass decoder and the second-pass decoder comprise a same decoder.

14. The computer-implemented method of claim 12, wherein the non-causal audio-text encoder comprises one of:
a plurality of unidirectional long short-term memory (LSTM) layers;
a plurality of conformer layers; or
a plurality of transformer layers.

15. A system comprising:
data processing hardware; and
memory hardware in communication with the data processing hardware, the memory hardware storing instructions that when executed on the data processing hardware cause the data processing hardware to perform operations comprising:
receiving a textual prompt in a first language;
obtaining a fine-tuned prompt embedding configured to guide a large language model (LLM) to generate text in a target language from textual prompts in the first language;
processing, using the LLM, the textual prompt conditioned on the fine-tuned prompt embedding to generate output text in the target language;
concatenating the textual prompt and the generated output text to provide an unspoken textual utterance; and
training a multilingual automatic speech recognition (ASR) model to learn how to recognize speech in the target language by injecting the unspoken textual utterance into a text encoder associated with the multilingual ASR model.

16. The system of claim 15, wherein the output text generated in the target language comprises monolingual text in the first language.

17. The system of claim 16, wherein the textual prompt comprises a prefix of a seed sentence in the first language, the seed sentence sampled from a set of multilingual seed sentences, the set of multilingual seed sentences comprising a plurality of monolingual seed sentence subsets, each monolingual seed sentence subset comprising corresponding seed sentences in a respective language different than the respective language of the corresponding seed sentences of each other monolingual seed sentence subset.

18. The system of claim 16, wherein the fine-tuned prompt embedding is learned during a fine-tuning process by:
obtaining a randomly initialized trainable prompt embedding;
obtaining a multilingual training dataset comprising a plurality of training data subsets, each training data subset including corresponding monolingual training text utterances in a respective language that is different than the respective language of the corresponding monolingual training text utterances included in each other training data subset;
for each monolingual training text utterance:
tokenizing the monolingual training utterance into a sequence of corresponding sub-word units; and
processing, using the LLM, the sequence of corresponding sub-word units to determine a training loss that maximizes a probability of predicting a next sub-word unit based on each of the preceding sub-word units in the sequence of sub-word units; and
fine-tuning, using the training losses, the randomly initialized trainable prompt embedding while parameters of the LLM are kept fixed.

19. The system of claim 18, wherein:
each corresponding training data subset of the plurality of training data subsets comprises one or more corresponding transcribed speech utterances each represented by a corresponding sequence of acoustic frames and paired with a corresponding transcription represented by a corresponding one of the monolingual training text utterances in the corresponding training data subset; and
training the multilingual speech recognition model further comprises training the multilingual speech recognition model on each of the one or more corresponding transcribed speech utterances in each corresponding training data subset of the plurality of training data subsets.

20. The system of claim 15, wherein the output text generated in the target language comprises text in a second language different than the first language.

21. The system of claim 20, wherein the textual prompt comprises a prefix of a seed sentence in the first language, the seed sentence sampled from a set of code-mixed seed sentences, each code-mixed seed sentence comprising corresponding code-mixed text in both the first language and the second language.

22. The system of claim 20, wherein the fine-tuned prompt embedding is learned during a fine-tuning process by:
obtaining a randomly initialized trainable prompt embedding;
obtaining a code-mixed training dataset comprising a plurality of code-mixed training text utterances that each comprise code-mixed text in the first language and the second language;
for each code-mixed training text utterance:
tokenizing the code-mixed training text utterance into a sequence of corresponding sub-word units; and
processing, using the LLM, the sequence of corresponding sub-word units to determine a training loss that maximizes a probability of predicting a next sub-word unit based on each of the preceding sub-word units in the sequence of sub-word units; and
fine-tuning, using the training losses, the randomly initialized trainable prompt embedding while parameters of the LLM are kept fixed.

23. The system of claim 22, wherein:
the code-mixed training dataset comprises one or more corresponding transcribed code-mixed speech utterances each represented by a corresponding sequence of acoustic frames and paired with a corresponding transcription represented by a corresponding one of the code-mixed training text utterances; and
training the multilingual speech recognition model further comprises training the multilingual speech recognition model on each of the one or more corresponding transcribed code-mixed speech utterances in the code-mixed training dataset.

24. The system of claim 15, wherein the LLM is pre-trained on a diverse range of text data sourced from web documents, books, and code.

25. The system of claim 15, wherein training the multilingual ASR model to learn how to recognize speech in the target language by injecting the unspoken textual utterance into the text encoder associated with the multilingual ASR model comprises:
tokenizing the unspoken textual utterance into a sequence of sub-word units;
generating, by the text encoder of an encoder, at each of a plurality of output steps, a first higher order textual feature representation for a corresponding sub-word unit in the sequence of sub-word units tokenized from the unspoken textual utterance;
receiving, as input to a first-pass decoder, the first higher order textual feature representation generated by the text encoder at each of the plurality of output steps; and
generating, by the first-pass decoder, at each of the plurality of output steps, a first probability distribution over possible text units; and
training the encoder based on the first probability distribution over possible text units generated by the first-pass decoder at each of the plurality of output steps for the unspoken textual utterance.

26. The system of claim 25, wherein the operations further comprise:
receiving, as input to a non-causal audio-text encoder of the encoder, the first higher order textual feature representation generated by the text encoder at each of the plurality of output steps;
generating, by the non-causal audio-text encoder, at each of the plurality of output steps, a second higher order textual feature representation for a corresponding first higher order textual feature representation;
receiving, as input to a second-pass decoder, the second higher order textual feature representation generated by the non-causal audio-text encoder at each of the plurality of output steps; and
generating, by the second decoder, at each of the plurality of output steps, a second probability distribution over possible text units,
wherein training the encoder is further based on the second probability distribution over possible text units generated by the second-pass decoder at each of the plurality of output steps for the unspoken textual utterance.

27. The system of claim 26, wherein the first-pass decoder and the second-pass decoder comprise a same decoder.

28. The system of claim 26, wherein the non-causal audio-text encoder comprises one of:
a plurality of unidirectional long short-term memory (LSTM) layers;
a plurality of conformer layers; or
a plurality of transformer layers.
